(19) United States
(12) Patent Application Publication
(10) Pub. No.: US 2010/0238176 A1
(43) Pub. Date: Sep. 23, 2010

(54) SYSTEMS, METHODS, AND DEVICES FOR FLASH EXPOSURE CONTROL USING PREFLASH STATISTICS

(75) Inventors: Haitao Guo, San Jose, CA (US); David Daming Kuo, San Jose, CA (US)

Correspondence Address: APPLE INC.;c/o Fletcher Yoder, PC, P.O. Box 692289, Houston, TX, 77269-2289, US

(73) Assignee: APPLE INC., Cupertino, CA (US)

(21) Appl. No.: 12/793,402

(22) Filed: Jun. 3, 2010

Related U.S. Application Data
(63) Continuation-in-part of application No. 12/422,808, filed on Apr. 13, 2009, now Pat. No. 7,721,209.
Application No. 12/422,808 is a continuation-in-part of application No. 12/206,217, filed on Sep. 8, 2008.

(51) Int. Cl. G06T 11/20; G06T 13/00

(52) U.S. Cl. 345/440; 345/473

(57) ABSTRACT

Techniques for accomplishing transitions between graphical data representations (e.g., charts, graphs, and so forth) are disclosed. In accordance with these techniques, each object in such a graphical data representation is individually manipulable during transitions. In certain embodiments, the presence of an object in both the outgoing and incoming graphical data representation may be taken into account during a transition. In such embodiments, differences between the objects in the outgoing and incoming graphical data representation may be addressed by the respective transition.

### CROSS-REFERENCE TO RELATED APPLICATIONS

This application is a continuation-in-part of U.S. patent application Ser. No. 12/422,808 entitled “Object-Aware Transitions”, filed Apr. 13, 2009, which is in turn a continuation-in-part of U.S. patent application Ser. No. 12/206,217, entitled “Object-Aware Transitions”, filed Sep. 8, 2008, both of which are herein incorporated by reference in their entirety for all purposes.

### BACKGROUND

1. Technical Field

The present invention relates generally to transitioning between sequential screens of slideshow presentations.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

One use which has been found for computers has been to facilitate the communication of information to an audience. For example, it is not uncommon for various types of public speaking, (such as lectures, seminars, classroom discussions, keynote addresses, and so forth), to be accompanied by computer generated presentations that emphasize or illustrate points being made by the speaker. For example, such presentations may include music, sound effects, images, videos, text passages, numeric examples or spreadsheets, or audiovisual content that emphasizes points being made by the speaker.

Typically, these presentations are composed of “slides” that are sequentially presented in a specified order. Typically, to transition between slides, a first slide would be replaced by a second slide on the screen. In some circumstances, some form of animation might be performed on the slides as they move on and off. However, the slides themselves are generally static images. Due to the prevalence of such computer-generated and facilitated presentations, one challenge is to maintain the interest level generated by such presentations, i.e., to keep the audience interested in the material being presented on the screen.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for providing object-aware transitions between slides of a presentation. Such object-aware transitions may include identifying each object on the slides being transitioned in and out. The objects or object-types may then be individually manipulated as part of the transition, such as by application of various effects, That is, the transition process may account for and independently animate or otherwise transition each of the objects or object-types composing the different slides.

In some instances, such object awareness can be leveraged as part of the transition. For example, in one embodiment, the same object, such as a graphic, word, number, or characters in a word or number, may be present in both the outgoing and incoming slides. In one such example, the transition may take advantage of the presence of the common objects in the outgoing and incoming slides to provide an effect or animations specifically for those objects present in both slides. In this way, the presence of the object in both slides may be used to tailor the slide transition.

Further, certain composite graphics may be decomposed into constituent components or objects to facilitate alterations to the composite graphic. Examples of such composite graphics include charts, graphs, or other graphical data representations visually depicting an underlying data set. In such an example, the chart may be composed of multiple constituent objects representing data or display features of the chart (e.g., bars, tick marks, axes, legends, labels, gridlines, numbers, and so forth). By animating or otherwise depicting changes to individual constituent chart objects over time a transition may be provided between a first chart and a second without redrawing the entirety of the chart (or other composite data graphic).

For example, in one embodiment, a second or subsequent chart (such as a chart in a spreadsheet or on an incoming slide of a slideshow presentation) may reflect a change in the underlying data, style information, and/or geometry compared to a preceding chart (such as a chart depicted within the spreadsheet or on an outgoing slide of a slideshow presentation). In such an embodiment, the differences in the respective charts may be reflected by particular differences between some or all of the constituent objects forming the respective charts. An animated or other visual transition may be provided for these different objects so that the first chart is altered to become the second chart without drawing the entire second chart. While certain of the present examples pertain to presentation applications and slide transitions within such applications, the present techniques may be applied in other contexts in which composite data graphics (e.g., charts) are employed and/or may be altered. For example, the present approaches may also be applied in the contexts of spreadsheet programs, database programs, or other work place productivity applications in which charts or other composite data graphics may be used to visually depict quantitative or qualitative data.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a perspective view illustrating an electronic device in accordance with one embodiment;

FIG. 2 is a simplified block diagram illustrating components of an electronic device in accordance with one embodiment;

FIG. 3 depicts a slide including objects in accordance with one embodiment;

FIG. 4 depicts the slide of FIG. 3 undergoing a transition in accordance with one embodiment;

FIGS. 5A-5F depict screenshots of an object-aware slide transition in accordance with one embodiment;

FIGS. 6A-6D depict screenshots of another object-aware slide transition in accordance with one embodiment;

FIGS. 7A-7I depict screenshots of a further object-aware slide transition in accordance with one embodiment;

FIGS. 8A-8F depict screenshots of an additional object-aware slide transition in accordance with one embodiment;

FIGS. 9A-9F depict screenshots of another object-aware slide transition in accordance with one embodiment;

FIG. 10 is a flowchart depicting steps for identifying and matching objects on a pair of slides in accordance with one embodiment;

FIG. 11 is a flowchart depicting additional steps for identifying and matching objects in slides in accordance with one embodiment;

FIG. 12 is a flowchart depicting steps for animating objects during a slide transition in accordance with one embodiment;

FIGS. 13A-13I depict screenshots of an object-aware slide transition with persistent objects in accordance with one embodiment;

FIGS. 14A-14F depict screenshots of another object-aware slide transition with persistent objects in accordance with one embodiment;

FIG. 15 is a flowchart depicting steps for animating objects associated with charts during a slide transition in accordance with one embodiment;

FIG. 16 is a flowchart depicting steps for animating objects associated with charts after a change in parameters in accordance with one embodiment;

FIG. 17 depicts an outgoing slide having a first chart, in accordance with one embodiment;

FIG. 18 depicts an incoming slide having a second chart, in accordance with one embodiment;

FIG. 19 depicts the first chart of FIG. 17;

FIG. 20 depicts a first step transitioning between the first chart of FIG. 17 and the second chart of FIG. 18, in accordance with one embodiment;

FIG. 21 depicts a second step transitioning between the first chart of FIG. 17 and the second chart of FIG. 18, in accordance with one embodiment;

FIG. 22 depicts a third step transitioning between the first chart of FIG. 17 and the second chart of FIG. 18, in accordance with one embodiment; and

FIG. 23 depicts the second chart of FIG. 18.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The disclosure is generally directed to providing object-aware transitions between subsequently presented data representations or graphics, such as sequentially presented slides, charts and so forth. In particular, in accordance with the present disclosure, different objects within each representation are identified and can be separately and independently handled during transitions, such as chart or slide transitions. In certain embodiments, this involves identifying objects present in both an outgoing and incoming slide and providing specific animation or handling for those objects.

For example, a slide transition between charts on consecutive slides may be accomplished by identifying the various constituent objects of the charts and modifying those objects that are different as part of the slide transition. In one embodiment, such a transition between charts may be implemented where the differences between the respective charts reflect changes in style information, geometry, and/or an underlying set of data represented by the respective charts. With this in mind, an example of a suitable device for use in accordance with the present disclosure is as follows.

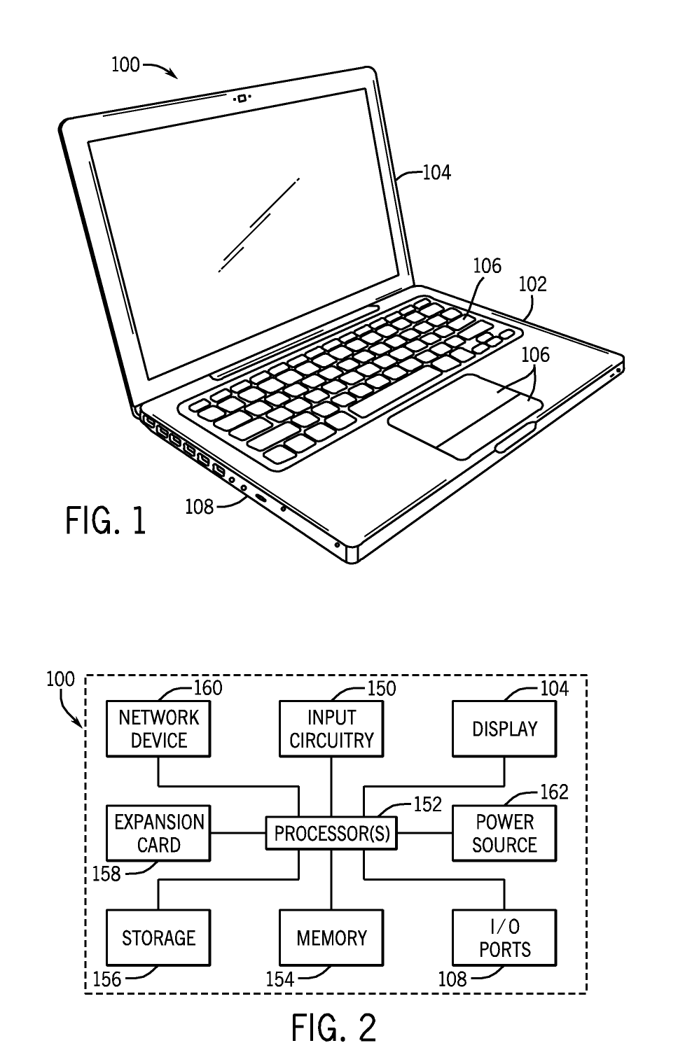

An exemplary electronic device 100 is illustrated in FIG. 1 in accordance with one embodiment of the present invention. In some embodiments, including the presently illustrated embodiment, the device 100 may be processor-based system, such as a laptop, tablet, or desktop computer, suitable for preparing and/or displaying presentations, such as using the Keynote® software package available from Apple Inc as part of the iWork® productivity package. Other processor-based systems suitable for preparing and/or displaying presentations may include servers, thin-client workstations, portable or handheld devices capable of running presentation software, or the like. By way of example, the electronic device 100 may be a model of a MacBook®, MacBook® Pro, MacBook Air®, iMac®, Mac® mini, Mac Pro®, iPhone®, iPod®, or tablet computing device available from Apple Inc. Thus, though FIG. 1 depicts an electronic device 100 in a laptop or notebook computer embodiment, such a depiction is merely for illustration and should not be viewed as limiting. It should be understood that an electronic device 100 may be any device capable of running presentation software, including laptop, tablet, and desktop computer systems as well as handheld and/or portable processor-based systems suitable for running software applications.

In the presently illustrated embodiment, the exemplary electronic device 100 includes an enclosure or housing 102, a display 104, input structures 106, and input/output connectors 108. The enclosure 102 may be formed from plastic, metal, composite materials, or other suitable materials, or any combination thereof. The enclosure 102 may protect the interior components of the electronic device 100 from physical damage, and may also shield the interior components from electromagnetic interference (EMI).

The display 104 may be a liquid crystal display (LCD), organic light emitting diode (OLED) display, cathode ray tube (CRT) or other suitable display type. For example, in one embodiment, a suitable LCD display may be based on light emitting diodes (LED) of compact fluorescent lights providing a backlight that is modulated by pixels of a LCD panel. In one embodiment, one or more of the input structures 106 are configured to control the device 100 or applications running on the device 100. Embodiments of the portable electronic device 100 may include any number of input structures 106, including buttons, switches, a mouse, a control or touch pad, a keyboard, or any other suitable input structures. The input structures 106 may operate to control functions of the electronic device 100 and/or any interfaces or devices connected to or used by the electronic device 100. For example, the input structures 106 may allow a user to navigate a displayed user interface or application interface.

The exemplary device 100 may also include various input and output ports 108 to allow connection of additional devices. For example, the device 100 may include any number of input and/or output ports 108, such as headphone and headset jacks, video ports, universal serial bus (USB) ports, IEEE-1394 ports, Ethernet and modem ports, and AC and/or DC power connectors. Further, the electronic device 100 may use the input and output ports 108 to connect to and send or receive data with any other device, such as a modem, external display, projector, networked computers, printers, or the like. For example, in one embodiment, the electronic device 100 may connect to a scanner, digital camera or other device capable of generating digital images (such as an iPhone or other camera-equipped cellular telephone) via a USB connection to send and receive data files, such as image files.

The electronic device 100 includes various internal components which contribute to the function of the device 100. FIG. 2 is a block diagram illustrating the components that may be present in the electronic device 100 and which may allow the device 100 to function in accordance with the techniques discussed herein. Those of ordinary skill in the art will appreciate that the various functional blocks shown in FIG. 2 may comprise hardware elements (including circuitry), software elements (including computer code stored on a machine-readable medium) or a combination of both hardware and software elements. It should further be noted that FIG. 2 is merely one example of a particular implementation and is merely intended to illustrate the types of components that may be present in a device 100 that allow the device 100 to function in accordance with the present techniques.

In the presently illustrated embodiment, the components may include the display 104 and the I/O ports 108 discussed above. In addition, as discussed in greater detail below, the components may include input circuitry 150, one or more processors 152, a memory device 154, a non-volatile storage 156, expansion card(s) 158, a networking device 160, and a power source 162.

The input circuitry 150 may include circuitry and/or electrical pathways by which user interactions with one or more input structures 106 are conveyed to the processor(s) 152. For example, user interaction with the input structures 106, such as to interact with a user or application interface displayed on the display 104, may generate electrical signals indicative of the user input. These input signals may be routed via the input circuitry 150, such as an input hub or bus, to the processor(s) 152 for further processing.

The processor(s) 152 may provide the processing capability to execute the operating system, programs, user and application interfaces, and any other functions of the electronic device 100. The processor(s) 152 may include one or more microprocessors, such as one or more “general-purpose” microprocessors, one or more special-purpose microprocessors and/or ASICS, or some combination thereof. For example, the processor 152 may include one or more instruction processors, as well as graphics processors, video processors, and/or related chip sets.

As noted above, the components may also include a memory 154. The memory 154 may include a volatile memory, such as random access memory (RAM), and/or a non-volatile memory, such as read-only memory (ROM). The memory 154 may store a variety of information and may be used for various purposes. For example, the memory 154 may store firmware for the electronic device 100 (such as a basic input/output instruction or operating system instructions), other programs that enable various functions of the electronic device 100, user interface functions, processor functions, and may be used for buffering or caching during operation of the electronic device 100.

The components may further include the non-volatile storage 156. The non-volatile storage 156 may include flash memory, a hard drive, or any other suitable optical, magnetic, or solid-state storage medium, or a combination thereof. The non-volatile storage 156 may be used to store data files such as media content (e.g., music, image, video, and/or presentation files), software (e.g., a presentation application for implementing the presently disclosed techniques on electronic device 100), wireless connection information (e.g., information that may enable the electronic device 100 to establish a wireless connection, such as a telephone or wireless network connection), and any other suitable data.

The embodiment illustrated in FIG. 2 may also include one or more card slots. The card slots may be configured to receive an expansion card 158 that may be used to add functionality to the electronic device 100, such as additional memory, I/O functionality, or networking capability. Such an expansion card 158 may connect to the device through any type of suitable connector, and may be accessed internally or external to the enclosure 102. For example, in one embodiment, the expansion card 158 may be a flash memory card, such as a SecureDigital (SD) card, mini- or microSD, CompactFlash card, Multimedia card (MMC), or the like.

The components depicted in FIG. 2 also include a network device 160, such as a network controller or a network interface card (NIC). In one embodiment, the network device 160 may be a wireless NIC providing wireless connectivity over any 802.11 standard or any other suitable wireless networking standard. The network device 160 may allow the electronic device 100 to communicate over a network, such as a Local Area Network (LAN), Wide Area Network (WAN), or the Internet. Further, the electronic device 100 may connect to and send or receive data with any device on the network, such as portable electronic devices, personal computers, printers, and so forth. Alternatively, in some embodiments, the electronic device 100 may not include a network device 160. In such an embodiment, a NIC may be added into card slot 158 to provide similar networking capability as described above.

Further, the components may also include a power source 162. In one embodiment, the power source 162 may be one or more batteries, such as a lithium-ion polymer battery. The battery may be user-removable or may be secured within the housing 102, and may be rechargeable. Additionally, the power source 162 may include AC power, such as provided by an electrical outlet, and the electronic device 100 may be connected to the power source 162 via a power adapter. This power adapter may also be used to recharge one or more batteries if present.

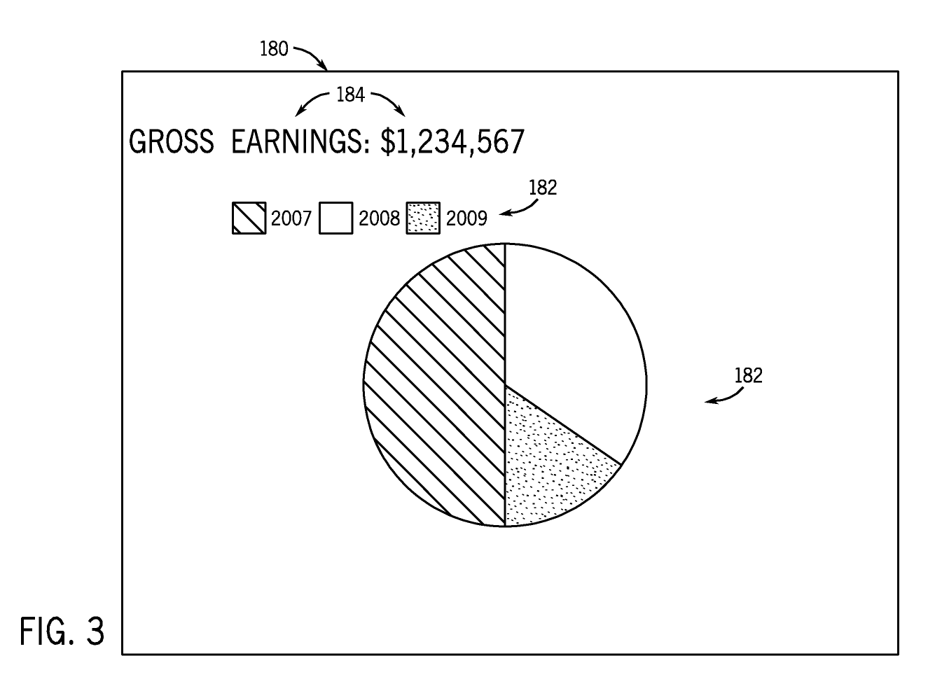

With the foregoing discussion in mind, various techniques and algorithms for implementing aspects of the present disclosure on such devices 100 and accompanying hardware and memory devices are discussed below. Turning to FIG. 3, a slide 180 having graphic objects 182 and character objects 184 (i.e., text and/or numbers or strings of text and/or numbers) is depicted. Such a slide 180 is typically one part of a presentation that typically includes many slides that are sequentially displayed. For example, such a presentation (and the individual slides of the presentation) may be composed in an application (such as Keynote® available from Apple Inc.) suitable for generating and displaying presentations on electronic device 100. In certain embodiments, such applications, or aspects of such applications, may be encoded using a suitable object-oriented programming language, such as Objective-C, C++, C#, and so forth.

As used herein, a “slide” should be understood to refer to a discrete unit on which one or more objects may be placed and arranged. Such slides should also be understood to be discrete units or elements of an ordered or sequential presentation, i.e., the slides are the pieces or units that are assembled and ordered to generate the presentation. Such a slide, may be understood to function as a container or receptacle for a set of objects (as discussed below) that together convey information about a particular concept or topic of the presentation. A slide may contain or include different types of objects (e.g., text, numbers, images, videos, charts, graphs, and/or audio, and so forth) that explain or describe a concept or topic to which the slide is directed and which may be handled or manipulated as a unit due to their being associated with or contained on the slide unit.

The order or sequence of the slides in a presentation or slideshow is typically relevant in that the information on the slides (which may include both alphanumeric (text and numbers) and graphical components) is meant to be presented or discussed in order or sequence and may build upon itself, such that the information on later slides is understandable in the context of information provided on preceding slides and would not be understood or meaningful in the absence of such context. That is, there is a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

As used herein, the term “object” refers to any individually editable component on a slide of a presentation. That is, something that can be added to a slide and/or be altered or edited on the slide, such as to change its location, orientation, size, opacity, or to change its content, may be described as an object. For example, a graphic, such as an image, photo, line drawing, clip-art, chart, table, which may be provided on a slide, may constitute an object. Likewise, a character or string of characters may constitute an object. Likewise, an embedded video or audio clip may also constitute an object that is a component of a slide. Therefore, in certain embodiments, characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or texture”.

Further, because a slide may contain multiple objects, the objects on a slide may have an associated z-ordering (i.e., depth) characterizing how the objects are displayed on the slide. That is, to the extent that objects on the slide may overlap or interact with one another, they may be ordered, layered or stacked in the z-dimension with respect to a viewer (i.e., to convey depth) such that each object is ordered as being above or beneath the other objects as they appear on the slide. As a result, in the event of an overlap of objects, a higher object can be depicted as overlying or obscuring a lower object. In this way, a slide may not only have a width and length associated with it, but also a depth (i.e., a z-axis).

Thus, as used herein, the term “slide” should be understood to represent a discrete unit of a slideshow presentation on which objects may be placed or manipulated. Likewise, an “object” as used herein should be understood to be any individually editable component that may be placed on such a slide. Further, as used herein, the term “transition” describes the act of moving from one slide to the next slide in a presentation. Such transitions may be accompanied by animations or effects applied to one or both of the incoming and outgoing slide. Likewise, the term “build” as used herein should be understood as describing effects or animations applied to one or more objects provided on a slide or, in some instances to an object or objects that are present on both an outgoing and incoming slide. For example, an animation build applied to an object on a slide may cause the object to be moved and rotated on the slide when the slide is displayed. Likewise, an opacity build applied to an object on a slide may cause the object to fade in and/or fade out on the slide when the slide is displayed.

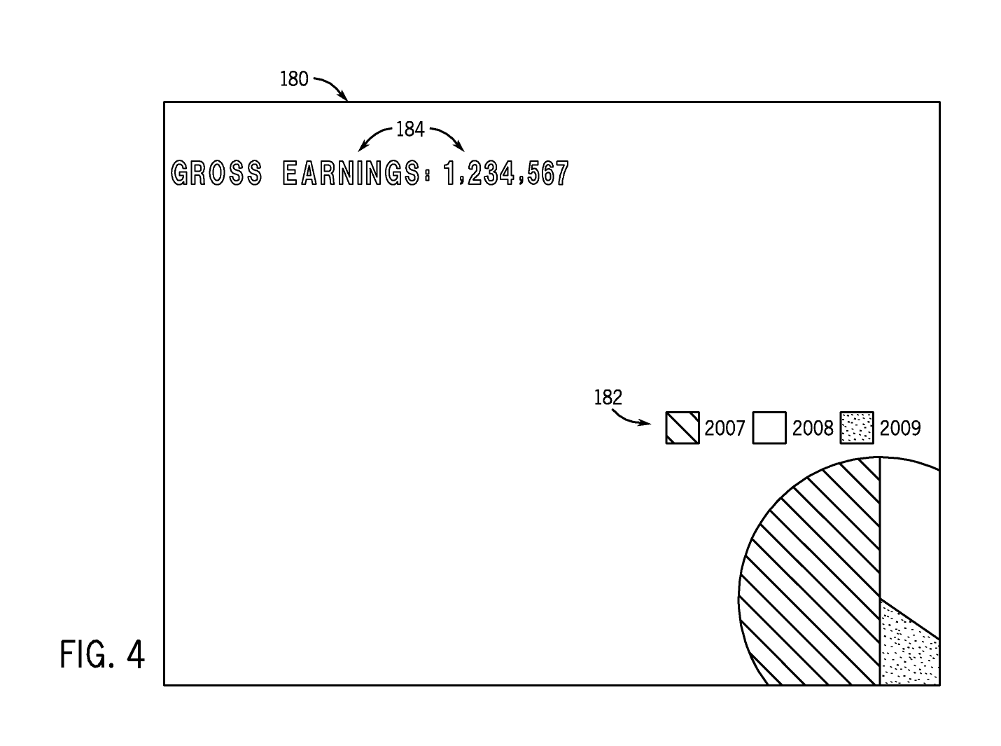

In one embodiment, the objects provided on the slides of a presentation are identified, automatically or by a user, allowing each object to be independently manipulated, such an animated, when transitioning between slides. That is, for a slide being transitioned out, each object may be separately handled, so that different objects or types of objects may undergo a different effect as part of the transition. For example, turning to FIG. 4, text and numeric objects 184 on the slide may fade out as graphic objects 182 are animated off the edges of the slide. Likewise, objects or object types on the incoming slide may also be independently handled, such as by fading in text on the incoming slide and animating the entrance of images of the incoming slide from above or from the sides.

By identifying each object on a slide, effects for transitioning an object on or off the screen may be specified (automatically or by a user) for each object or each type of object (such as graphics files, text boxes, videos, etc.) independently of one another. The effect used in transitioning an object may depend on some characteristic of the object, such as a file type, location on the slide, color, shape, size, and so forth. For example, how close an object is to an edge may be a factor in determining whether the object will be animated on to or off of a slide and, if such an animation is selected, which edge the animation will occur relative to, how fast the animation will occur, and so forth. While the transition effects for different objects or object types may be handled automatically in one embodiment (such as based upon the factors described above), in other embodiments, a user may specify what effects are associated with the transition of an object on or off the screen. For example, a user may use a presentation application interface screen to specify properties of one or more objects on a slide, including transition effects for moving the object on or off the screen.

Such object or content, aware transitions differ from traditional approaches to transition between slides in which each slide is represented by a static image (and, therefore, treated as a single unit) and transitions would generally be an animation between the static images. However, individual objects on the slides were not individually manipulated, such as animated, during transitions. Thus, object-aware transitions, in the present context, are transitions that have access to the different individual objects of which the slides or slides are composed, and where each object can be animated or otherwise manipulated independent of the others.

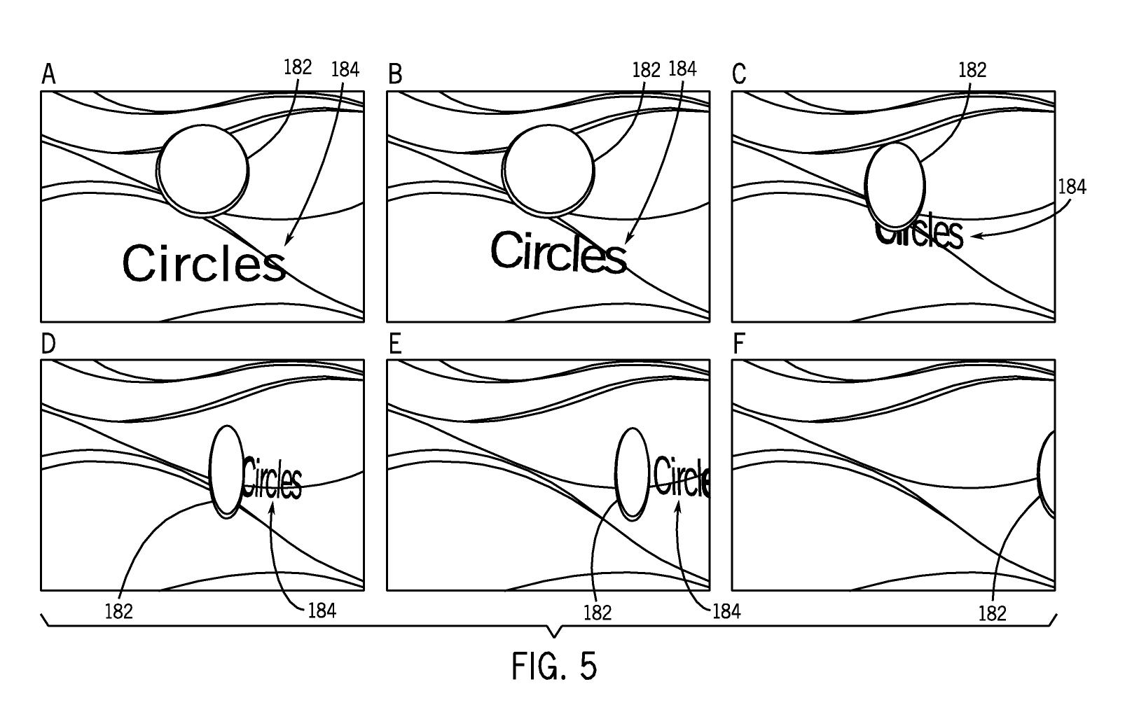

In terms of the various effects that each object can be subjected to in such object-aware transitions, virtually any animation and/or manipulation that can be performed on the respective type of object may be suitable. By way of example, turning now to FIGS. 5A-5F, a sequence of screenshots depicting an example of an animated slide transition is depicted. In this example, the animation may be characterized as a “rotate and slide” animation in which a graphic object 182, here a circle, is “rotated” while “sliding” off of the right side of the slide from the center. Independent of the graphic object 182, a character object 184, here the text string “Circles”, is also rotated and slid off the right of the slide. The character object 184, while rotating and sliding to the right of the slide, is also slid upward from beneath the circle to the vertical center of the slide while being animated off of the slide. Thus, the character object 184 and the graphic object 182 are animated independently of one another such that one object undergoes a different animation, i.e., vertical sliding, in the transition. It is also worth noting that the selected transition, such as “rotate and slide”, may be used to animate in the objects of the next sequential slide. For example, in an incoming slide, a graphic object and character object may be rotated and slid in from the vertical center of the left side of the next slide, with one or both objects also undergoing an upward or downward animation to achieve the desired presentation location on the slide.

In practice, the identification of the graphic and character objects in the slide may be accomplished automatically, such as by an algorithm of a presentation application that identifies such objects by file type extensions or other indicators, or by user designation that the slide component is an object for purposes of object-aware transitions. Once the objects are identified and a transition effect, such as “rotate and slide”, is selected for the slide by the user, the manner in which the selected effect is applied to each object in the slide may be determined automatically. For example, it may be automatically determined that all objects will rotate and slide off of the slide from the vertical center of the slide, and the animation of each object may be determined accordingly. Alternatively, in other embodiments, the user may be able to specify particular effects or animations for each object of the slide, or to specify the manner in which an effect is accomplished, such as with or without vertical centering for an individual object.

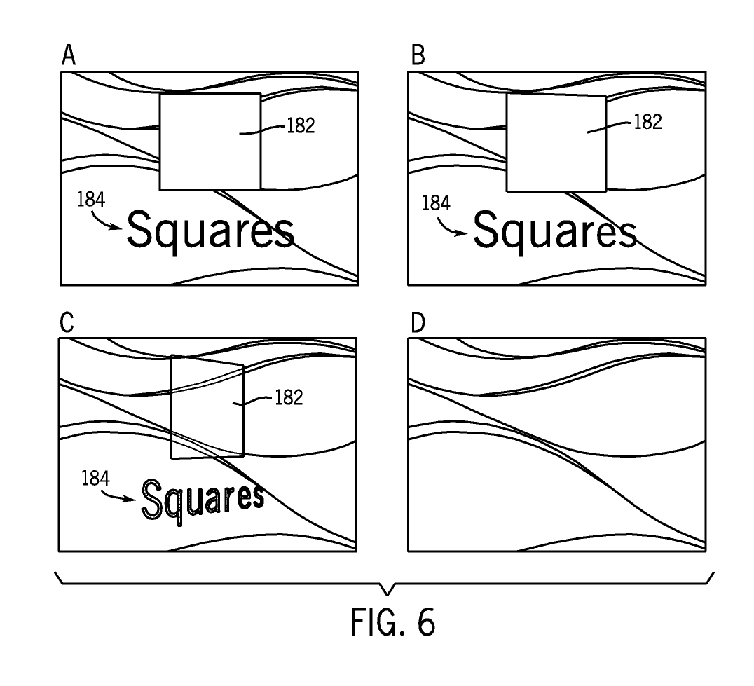

In another example, turning now to FIGS. 6A-6D, a sequence of screenshots depicting another animated slide transition is provided. In this example, the animation may be characterized as a “dissolve and flip” animation in which a graphic object 182, here a square, and a character object 184, here the text string “Squares”, are rotated in place, i.e., flipped, while dissolving or fading from view, such as by progressively increasing the transparency of the objects. As in the previous example, the character object 184 and the graphic object 182 are animated independently of one another. As noted above, the “dissolve and flip” transition may also be used to animate the objects of the next sequential slide to introduce those objects, though obviously in such an implementation, the objects will not be dissolving but appearing or materializing, i.e., opacity will be gradually increased for the objects during the transition.

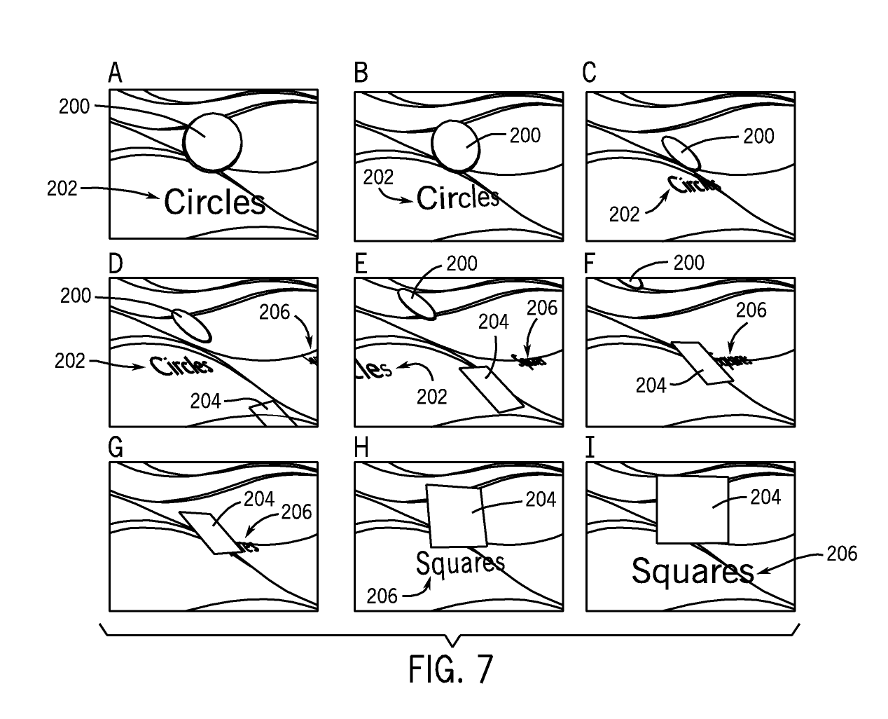

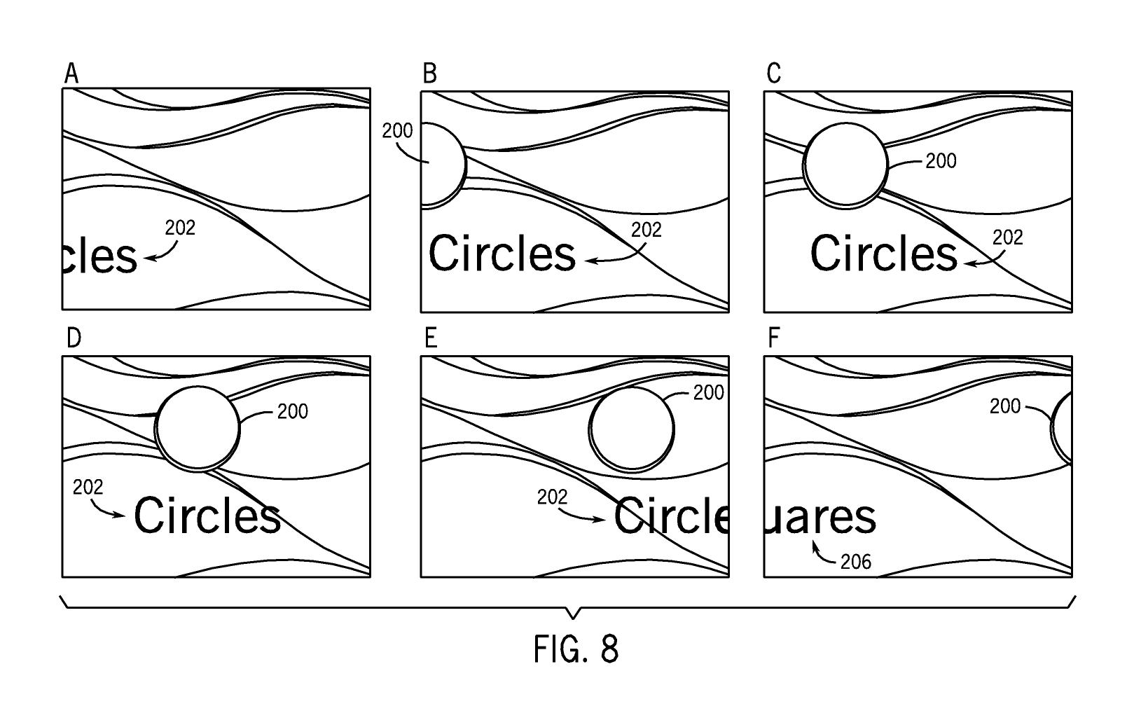

In yet another example, a sequence of screenshots depicting another animated slide transition is depicted in FIGS. 7A-7I. In this example, the animation may be characterized as an “isometric” animation in which, as depicted in FIGS. 7A-7F, a first graphic object 200, here a circle, and a first character object 202, here the text string “Circles”, are subjected to an isometric transformation and moved off the top and left edges, respectively, of a slide. As in the previous example, the first character object 202 and the first graphic object 200 are animated independently of one another, of other objects in the slide, and/or of other objects in the next slide. In addition, the sequence of screenshots depicts, in FIGS. 7D-7I, the animation onto the screen of a second graphic object 204, here a square, and a second character object 206, here the text string “Squares”. In the incoming transition of the second graphic object 204 and the second character object 206, these objects under go the reverse isometric transformation and slide in from opposite respective sides of the screen as their first slide counterparts. As noted above, the “isometric” transition for the incoming slide may also be applied to each object of the incoming slide in an independent manner and/or without regard for the objects of the previous slide.

In a further example, a sequence of screenshots depicting another animated slide transition is depicted in FIGS. 8A-8F. In this example, the animation may be characterized as an “object push” animation in which, as depicted in FIGS. 8A-8D, a first graphic object 200, here a circle, and a first character object 202, here the text string “Circles”, are “pushed” in from the left side of the slide. In the depicted example, the first graphic object 200 and the first character object 202 are pushed in at different speeds, e.g., the first graphic object 200 is lagging, though, at the end of the push in animation, the first graphic object 200 is aligned over the center of the first character object 202. Thus, the first character object 202 and the first graphic object 200 move independently of one another, of other objects in the slide, and/or of other objects in the next slide. In addition, the sequence of screenshots depicts, in FIGS. 8E-8F, the first graphic object 200 and the first character object 202 being pushed off the right side of the slide at different speeds, i.e., the graphic is lagging relative to the text, and a second character object 206 associated with the next slide is being pushed onto the slide from the left side. As with the previous slide, the “object push” transition for the incoming slide may also be applied to each object of the incoming slide in an independent manner (such as each object moving at a different speed or entering from a different direction) and/or without regard for the objects of the previous slide.

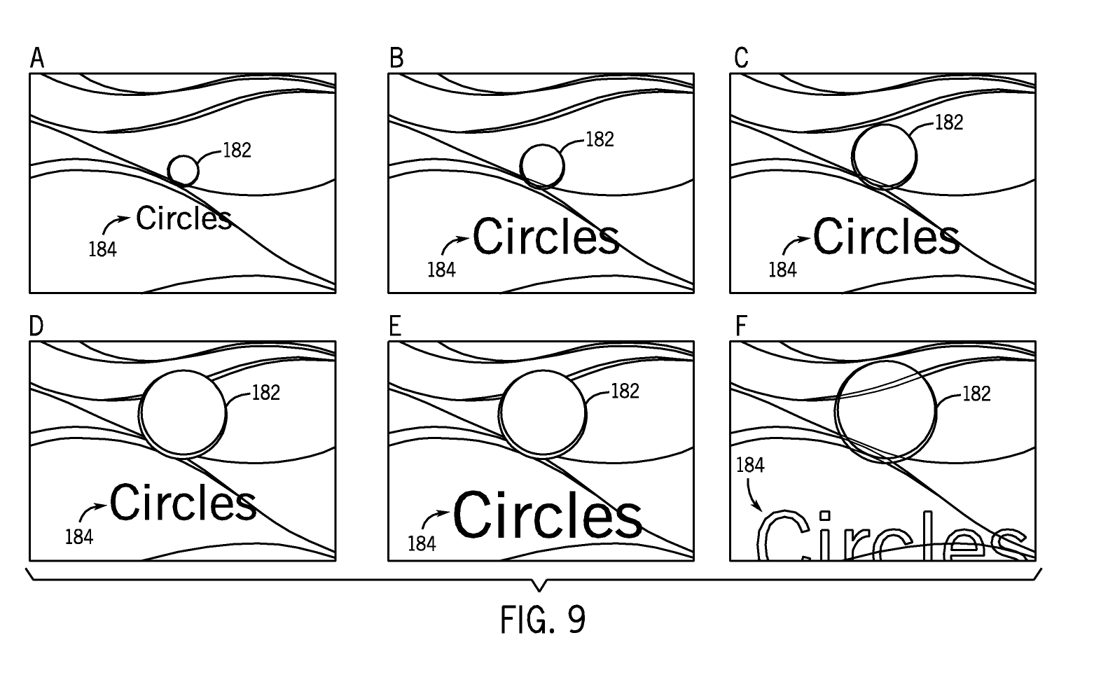

In another example, a sequence of screenshots depicting another animated slide transition is depicted in FIGS. 9A-9F. In this example, the animation may be characterized as an “object zoom” animation in which, as depicted in FIGS. 9A-9D, a graphic object 182, here a circle, and a character object 184, here the text string “Circles”, arise out of the slide. In the depicted example, the graphic object 182 and the character object 184 rise up or appear at different times, i.e., the character object 184 is discernible first. Thus, the character object 184 and the graphic object 182 are animated independently of one another, of other objects in the slide, and/or of other objects in the next slide. In addition, the sequence of screenshots depicts, in FIGS. 9E-9F, the exiting transition of the graphic object 182 and the character object 184 from the slide. In this outgoing transition the graphic object 182 and the character object 184 rise off the surface of the slide until they disappear, with the character object 184 disappearing first. As with the previous slide, the “object zoom” transition for the outgoing objects may be applied to each object in an independent manner (such as each object moving, appearing, or disappearing at a different speed) and/or without regard for the objects of the next slide.

The preceding examples are illustrative of the manner in which individual objects on a slide may be differentially or independently manipulated, e.g., animated, without regard to other objects in a slide. The preceding examples, however, are not exhaustive, and it is to be understood that any animation or manipulation suitable for an object identified in a slide may be applied to that object without regard to the other objects in the slide or the objects in the previous or next slides in certain object-aware transition embodiments.

Further, as previously noted, the identification and assignment of animations may be largely automatic in some embodiments. For example, a user may design two or more sequential slides, such as by placing the desired objects on each slide in the desired locations. The user may then simply select a type of transition, such as the above-described isometric transition, for transitioning between two or more of the slides. In an automated implementation, the presentation application may, knowing only the selected transition and the type and location of the objects on the slides, assign suitable animation direction, speeds, effects, translucencies, and other animation effects to each object being transitioned in and out.

The preceding discussion describes implementations in which the transitions between slides do not take into account what the objects are that are in the slides or whether the same object is present in both the outgoing and incoming slide. However, in certain embodiments, the object-aware transition may take such object persistence into account. For example, in certain implementations where the same object, be it a text, numeric, graphic, and/or video object, is present in consecutive slides, an animation or manipulation may be applied to the object while maintaining the object on the screen. Thus, in one implementation, an object may be present in consecutive slides (though it may be in different locations, orientations, opacities, or at a different scale in the two slides) and an animation may be applied to the object such that the object appears to move, turn, resize, and so forth to reach the appropriate size, location, opacity, and/or orientation in the second slide after the transition.

As in the previously described embodiments, the identification of the object may be performed automatically or based on user inputs. In addition, the determination that the object is present in consecutive slides, though perhaps with different size, opacity, rotation, or location properties, may be performed automatically. For example, the object may be a .jpg or a .gif image which is referenced by a common file name or location (such as an image gallery or library) when placed on the first and second slides or may be a text or numeric object that contains the same characters. Thus, an automated routine may determine that the same image file or character string (word, phrase, sentence, paragraph, and so forth) is present in both slides, even if it is at different locations in the slides or at different sizes. The presentation application may then also evaluate different attributes of the common object, such as size, position, color, rotation, font, and so forth, to determine if any of these attributes that differ between slides would preclude animation from one to the other. If however, the differences are susceptible to a transitional animation, the presentation application may automatically determine an animation for the transition between slides such that the common object appears to be moved, scaled, rotated, and so forth into the proper location for the incoming slide. Thus, in this embodiment, the user may do no more than design two sequential slides with one or more objects in common and the presentation application will identify the common objects on the sequential slides and provide appropriate animated transitions for the common objects when going from the first slide to the second.

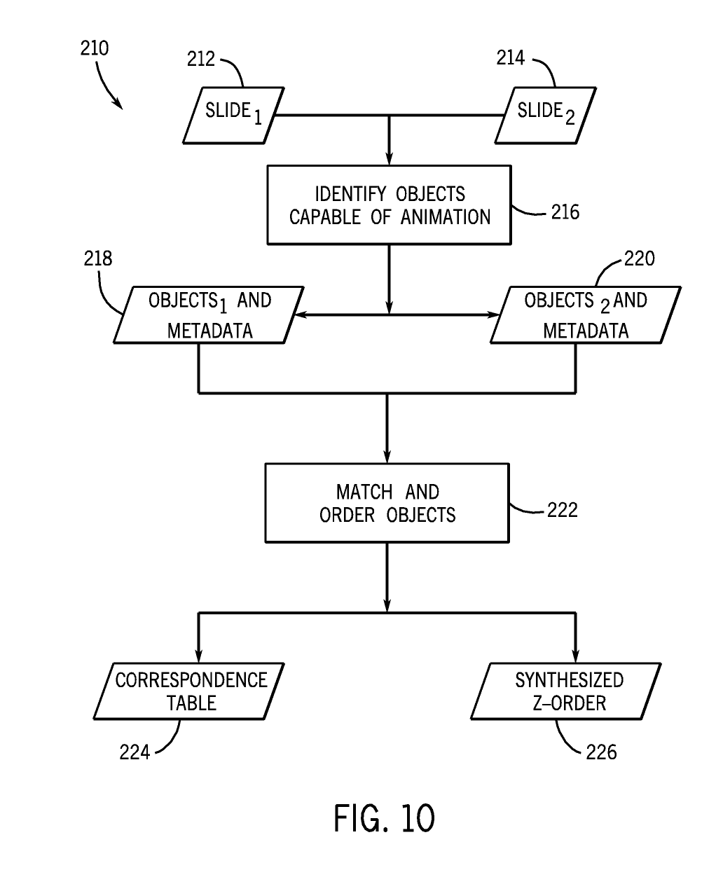

By way of example and turning now to FIG. 10, one example of a technique suitable for automatically identifying and matching objects on an outgoing and an incoming slide is provided. In FIG. 10 a flowchart 210 is provided depicting exemplary inputs, outputs, and processes that may be used in identifying and matching objects in a pair of slides.

In this example, a first slide 212 and a second slide 214 are provided to a routine capable of identifying (block 216) objects that can be animated and of acquiring information (e.g., metadata) associated with each identified object. For example, the identification process may be based on file name extensions, presence of text or characters, and so forth. In some embodiments, identified objects may also be generally characterized or classified based on the identifying feature (such as an image, shape, table, chart, movie, character string, etc.) to facilitate subsequent processing. In addition, as noted above, information or metadata for each identified object may also be determined. Such information or metadata may include, but is not limited to: a filename, a Bezier path describing a custom shape (such as a square, circle, star, and so forth), text attributes (such as automatic capitalization style, font metric information, or the character string itself), shadows and/or reflections applied to the object, masks or alpha masks applied to the object, rotation and/or scaling applied to the object, and so forth.

The objects and associated metadata 218, 220 identified for the respective first and second slides 212, 214 may be used to match and order (block 222) the objects such that objects present in both the first slide 212 and the second slide 214 are identified. For example, the objects identified in the first slide 212 and the second slide 214 may be compared in a pairwise process such that each object is matched with a corresponding object in the other slide or is determined to be present in only the first slide or the second slide (i.e., is unmatched). Based on the matching process, a correspondence table 224 may be generated specifying which objects in the first slide 212 correspond to which objects in the second slide 214.

In certain embodiments, different degrees of matching may be accommodated in the correspondence table 224. For example, an object may be determined to be present in both the first slide 212 and the second slide 214 in an identical form or with only changes in location, rotation, scale, and/or opacity. Such a match may be considered a “hard” or “solid” match in view of the certainty that the object is the same, i.e., is matched, or in view of the relative ease by which the object can be transformed from its form in the first slide 212 to its form in the second slide 214. Further, some metadata may indicate a clear identity match, such as where two image filenames are the same or where two text strings are identical and have the same style and metric information.

In other instances, a match may be construed to be a “soft” match where there is less certainty as to the match and/or where the transformation of the object between the first slide 212 and the second slide 214 is not simply a matter of moving, scaling, rotating or adjusting the opacity of the object. For example, an object in the first slide 212 and an object in the second slide 214 may have generally the same shape but may have different shadow styles, reflection styles, and/or fill styles. Such objects may be deemed to be a soft match in that they may represent the same object in the first and second slides 212, 214 but with some difference or differences that are not resolvable simply by moving, scaling, rotating, and/or changing the opacity of the object.

In addition to establishing the correspondence between objects in the first and second slides 212, 214, the matching and ordering step (block 222) may also establish an ordering 226 of the identified objects in the Z-dimension of the slides, i.e., in the depth dimension with respect to the slides. For example, different effect layers which can be viewed as overlying or underlying a slide may be viewed as being different layers in the Z-dimension. Such a synthesized Z-ordering 226 may be generated using the relative Z-positions of each object on the first slide 212 and/or second slide 214 such that the synthesized Z-ordering 226 provides a transitional or bridge Z-ordering between the two slides that may be used in a transition animation of the matched objects.

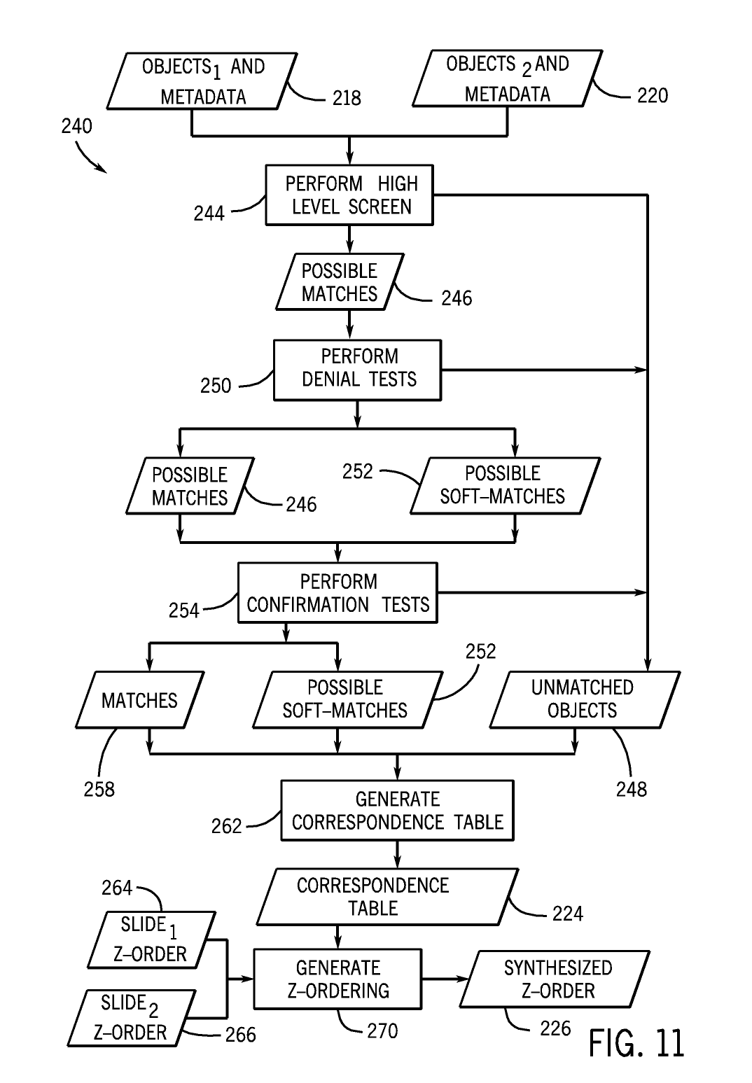

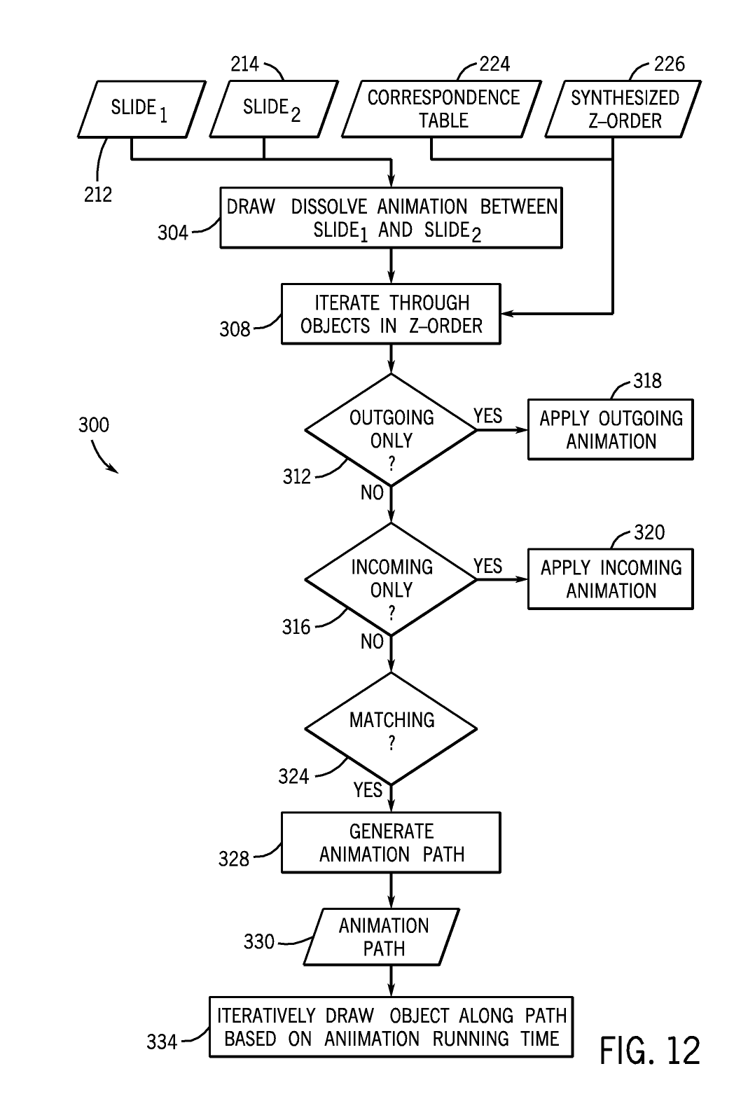

Turning now to FIG. 11, one example of a specific implementation of such a matching and ordering process is provided. In the flowchart 240 of FIG. 11, the identified objects and associated metadata 218, 220 for the first and second slides 212, 214 (FIG. 10) may be derived as previously discussed. Both sets of objects 218, 220 may be initially subjected to a high level screen (block 244) based on respective metadata characterizing the different object types (e.g., images, shapes, tables, charts, movies, character strings, and so forth). If an object on one slide can be characterized (based on filename extension or some other suitable metadata) as being a type of object which is not represented on the other slide, the object may be characterized as an unmatched object 248 without further analysis. For example, an object present on the first slide 212 may be characterized as a movie based on a filename extension (e.g., .mov, .avi, .mpg, and so forth). If no object on the second slide 214 is characterized as a movie, no additional analysis is needed to determine that the movie object on the first slide cannot be matched with an object on the second slide since there is no movie on the second slide.

However, if the high level screen (block 244) determines that objects on both the first and second slide 212, 214 may potentially be matches 246 due to the objects being the same type, the objects in question may be characterized as possible matches 246. The possible matches 246 may be subjected to additional analysis to determine if object matches are present in both outgoing and incoming slides. For example, in the depicted embodiment, the possible matches 246 may be subjected (block 250) to denial testing to determine whether objects found in the first and second slide 212, 214 are different from one another.

In one embodiment, such denial testing may be implemented in a pairwise manner, i.e., each object 218 of a given type on the first slide 212 may be compared in a pairwise manner with each object 220 of the same type on the second slide 214. For example, each image object on the first slide 212 may be compared with each image object on the second slide 214 to check for differences between each pair of image objects. Examples of differences which may be checked for include, but are not limited to, differences in the aspect ratios of the objects, different masks associated with the objects, different or dissimilar filenames, and so forth. If an object is determined to be different from every object of the same type in the other slide, the object may be characterized as an unmatched object 248. If an object cannot be unequivocally characterized as different from every object of the same type on the other slide, the object maybe characterized as a possible match 246.

In some embodiments, such as the depicted embodiment, the denial tests (block 250) may merely throw a match in doubt, without ruling a match out. For example, an object on the first slide and an object on the second slide may have different shadow styles, reflection styles, fill styles, and so forth, but may be otherwise similar. Such possible matches may be characterized as “soft” matches 252 in that the objects clearly have some degree of dissimilarity, but not sufficient dissimilarity to state with certainty that the objects are not identical except for some visual distinction, such as shadow, reflection, fill, border thickness, and so forth.

The possible matches 246 and possible soft matches 252 may be further subjected to a confirmation test (block 254) to determine whether objects found in the first and second slide 212, 214 are identical to one another. For example, a confirmation test may verify that text strings found in the first slide 212 and the second slide 214 are identical to one another and/or may verify that the font metric and style information are the same. Likewise, in confirmation testing image objects or movie objects, the confirmation test may confirm that the objects being compared share the same source file (such as by comparing file name and file location). Shape objects may be confirmation tested to confirm that the shape objects have the same border path, and so forth. Group objects may be confirmation tested to confirm that they share the same sub-objects and aspect ratio, and so forth. Failure of a confirmation test may result in an object being classified as an unmatched object 248. A successful confirmation of two objects in different slides may result in those objects being deemed matches 258. In some embodiments, a confirmation test may also deem two objects as a soft match where unequivocal confirmation is not available.

In one embodiment, when an object in the first slide 212 and an object in the second slide 214 successfully pass both denial tests and confirmation tests, the pair of objects may be marked as a set or match 258 and both objects will be removed from further pairwise comparisons. Likewise, if a pair of objects is judged a soft match in either or both of the denial or confirmation test, the pair of objects may be marked as a possible soft match 252. In some embodiments, such soft matched objects may be removed from further comparison while in other embodiments soft matched objects may be subjected to further pairwise comparisons to determine if a full or hard match can be confirmed.

Based on whether an object in the first slide 212 or second slide 214 is classified as being a match with an object in the other slide or as being unmatched with an object in the other slide, a correspondence table 224 may be generated (block 262). Such a correspondence table 224 may, in one embodiment, list each object in the two slides along with an indication of whether or not a match was identified and, if a match was identified, what object in the other slide constitutes the match. Alternatively, the correspondence table may only list the matched objects, with objects not listed on the table being understood to have no match. In embodiments in which soft matches are identified, the correspondence table 224 may contain an additional field or descriptor to indicate that the match is soft, i.e., not exact or identical. Further, in some embodiments, a numeric or quantitative measure of the certainty of the match may be provided in lieu of, or in addition to, a qualitative (i.e., “hard” or “soft”) assessment.

In the depicted example the correspondence table 224, along with the orders 264, 266 of objects in the first and second slides, may be used to generate (block 270) a synthesized Z-order 226 of the objects in the two slides 212, 214. In one example, to establish the synthesized Z-order 226 of the identified objects, the Z-order 264 of the objects identified on the first slide (e.g., the outgoing slide) may be used to initially populate the synthesized Z-order 226. For each unmatched object on the outgoing slide (e.g., first slide 212) a determination may be made of which matched object occurs next in the outgoing slide's Z-order 264 and the respective unmatched object is inserted immediately before that matched object in the synthesized Z-order list 226. The incoming slide (e.g., second slide 214) may be handled similarly, but in reverse order, to maintain the correct relative Z-orders. Once completed, the synthesized Z-order 226 may provide a composite listing of the objects on both the outgoing and incoming slides (i.e., first slide 212 and second slide 214) with the appropriate “depth” or layer for each object on the slides for use in an animated transition between the slides.

The correspondence table 224 and the synthesized Z-order may be used to generate a series of animation frames for transitioning from the first slide 212 to the second slide 214, as depicted by the flowchart 300 of FIG. 12. As part of one such transitional animation, a dissolve animation may be initially drawn (block 304) between the first slide 212 and the second slide 214. For example, the background of the first slide 212 may be dissolved, i.e., decreased in opacity, while the background of the second slide 214 is materialized, i.e., increased in opacity in the foreground.

In the depicted example, each object on the first slide 212 and the second slide 214 may be iteratively processed (block 308) based on the order specified in the synthesized Z-order 226. As part of the iterative processing, each object may be checked against the correspondence table 224 to determine if it is only on the outgoing slide (e.g., first slide 212), only on the incoming slide (e.g., second slide 214), or on both the outgoing and incoming slides.

If an object is determined (block 312) to be present on only the outgoing slide or is determined (block 316) to be present on only the incoming slide, a specified outgoing animation 318 or incoming animation 320 may be performed on the object. For example, if an object is determined to be only on the outgoing slide, the object may undergo a dissolve animation or an animation moving the object off the screen that occurs over all or part of a specified transition interval. For instance, in one embodiment an object present only on the outgoing slide may have its opacity increased from 0% to 100% over the entire transition interval. Conversely, an object present only in the incoming slide may undergo a materialize animation or an animation moving the object onto the screen over all or part of the specified transition interval. For example, an object present only on the incoming slide may have its opacity decreased from 100% to 0% over the entire transition interval.

In the depicted embodiment, if an object is determined (block 324) to be present in both the outgoing and incoming slides, an animation path 330 is generated (block 328) to transition the object from a final position on the outgoing slide and an initial position on the incoming slide. Information (e.g., metadata) about the object on each slide may be used in generating the animation path 330 to determine if the object has different position, scaling, rotation, and/or opacity on the two slides. If such differences are determined to exist for the object on the two slides, the animation path 330 may include moving, scaling, rotating, and/or changing the opacity of the object from how it appears on the first slide 212 to how it appears on the second slide 214 such that a smooth transition of the object is perceived.

To animate the transition of the object between the first and second slides 212, 214 the object may be iteratively drawn (block 334), i.e., animated, at appropriate positions along the animation path based on the elapsed time of the transition interval. For example, if the specified transition interval is 1 second and the animation is to occur at 60 frames per second, the object will be drawn 60 times during the 1 second transition, with each drawing of the object corresponding to a respective position on the animation path 330. That is, in this example, the first drawing of the object along the animation path 330 will occur at t₁= 1/60th of a second into the transition and will correspond to the object as it appears at a point or step 1/60 of the way along the animation path 330. Likewise, halfway through the transition animation, the object will be drawn at t₃₀=½ of a second into the transition and will correspond to the object as it appears at the halfway point of the animation path 330.

In certain embodiments, the designation of an object match as being a soft match may affect the transition animation. For example, an object present in both the first slide 212 and the second slide 214 may be characterized as a soft match due to having certain dissimilarities in the respective slides that are not sufficient to characterize the objects as unmatched (such as borders of different thickness on two otherwise identical shapes or different filler, shadow, or reflection effects applied to otherwise identical shapes). In one such embodiment, the animation path 330 may include a fade out of the object as it appears on the first slide and a fade in of the object as it appears on the second slide to smoothly fade in the dissimilar features. In such embodiments, shaders or shader functionality provided by a graphics processor or chipset may be used to generate weighted or intermediate images on the animation path 330 that correspond to transitional images of the object as it appears in the first and second slide 212, 214. In this manner, the dissimilarities between the object on the first and second slides 212, 214 may be smoothly faded out or in over the course of the transition animation.

In certain embodiments, the animation of unmatched objects may be handled differently if matched objects are present than when no matched objects are present. For example, in one embodiment, if no matched objects are present on the first slide 212 and the second slide 214, the respective objects may be faded out and faded in over the full transition interval. That is, in such an embodiment, the objects on the outgoing slide may be faded out (i.e., opacity increasing from 0% to 100%) over the full length of the transition interval, such as 2 seconds, while the incoming objects may be materialized (i.e., opacity decreasing from 100% to 0%) over same interval. However, in the presence of one or more matched objects on the first and second slides 212, 214, the animation of the unmatched objects may be altered, such as accelerated. For example, in the presence of one or more matched objects being animated along an animation path 330 during a slide transition, the unmatched objects may be undergo an accelerated, i.e., shorter, fade in or fade out animation. For instance, in such an example an unmatched object being faded out in the presence of matched objects may be faded out by the halfway point of the transition or less, such as by the time 25%, 30%, or 33% of the transition interval has elapsed. Similarly, an unmatched object being faded in the presence of matched objects may not begin fading in until the halfway point of the transition interval has been reached or later, such as by the time 66%, 70%, or 75% of the transition interval has elapsed.

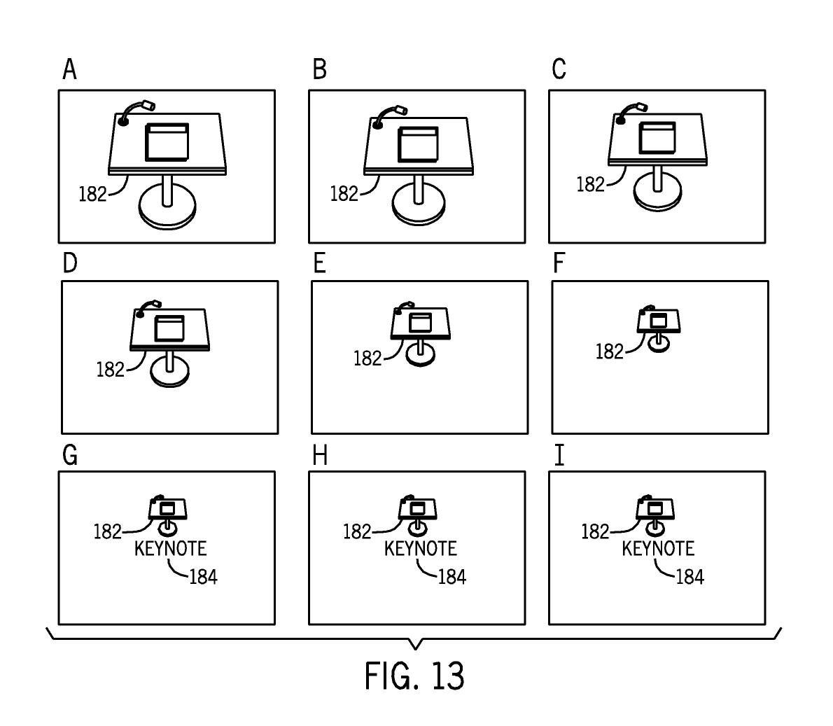

With the foregoing discussion in mind, certain examples of such object-aware transitions are provided where one or more objects are present in both the outgoing and the incoming slide. For example, turning now to FIGS. 13A-13I, a sequence of screenshots depicting a slide transition is depicted. In this example, a graphic object 182, here a stand, is present in both the outgoing and incoming slides. However, the graphic image 182 is at a different size and location in the first slide relative to the second slide. In addition, a character object 184, here the text string “Keynote”, is introduced in the second slide which is not present in the first slide. In the depicted example, the graphic object 182 is animated to appear to shrink and to move upward on the screen as part of the transition between slides. In addition, the character object 184 is added during the transition. As in previous embodiments, the graphic object 182 and character object 184 may be animated or manipulated independently of one another.

In another embodiment of an object-aware transition that takes into account the persistence of objects between slides, a character-based example is provided. In this example, the actual characters, be they letters, numbers, punctuation, etc., on a slide may be evaluated separately for persistence between slides. That is, the characters within a text and/or numeric string may be considered to be the objects in the present context. In an automated implementation, when evaluating the character objects to determine if the character object is present in consecutive slides, the presentation application may evaluate different attributes of the character, such as the letter or number itself, the font, the font size, the color, the presence of certain emphasis (highlight, underlining, italics, bold, strikethrough, and so forth) and other attributes that may affect the similarity of the perceived character in consecutive slides. In certain embodiments, the character might be identical across the evaluated attributes to be retained or animated between slides. In other embodiments, certain attributes, such as color changes, emphases, and so forth, may still allow animation and retention of the character between slides.

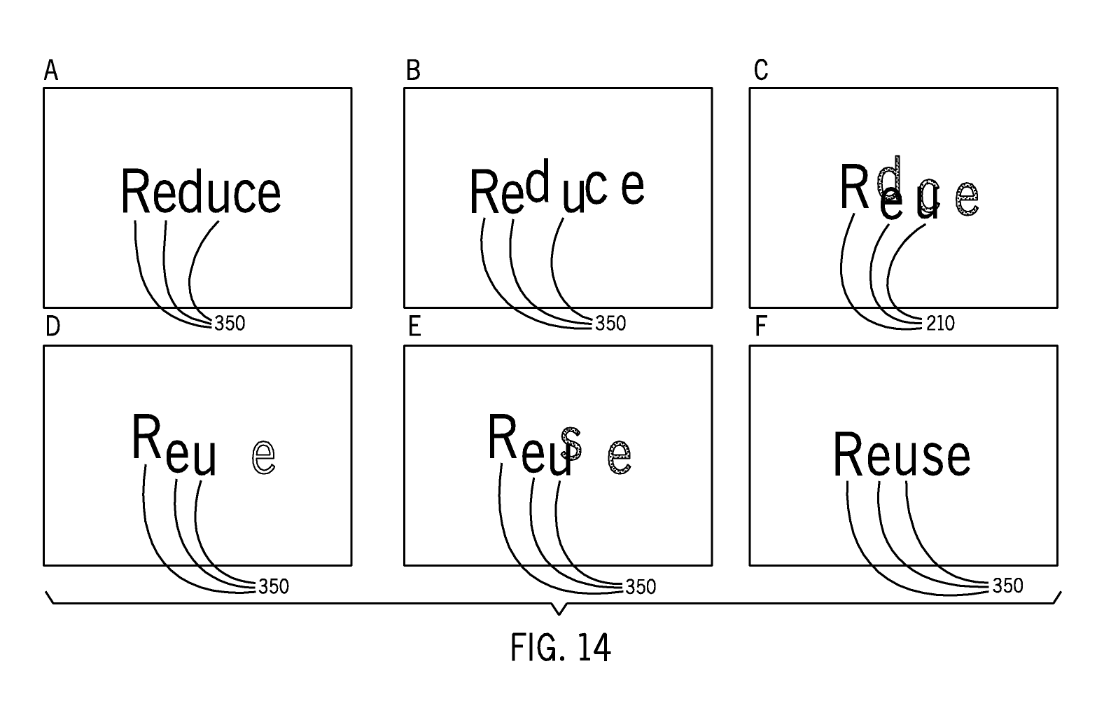

In this example, while the characters may be present in consecutive slides, they need no be used in the same words or numbers, and therefore need not remain in the same order. Turning to FIGS. 14A-14F, a sequence of screenshots depicting a slide transition is depicted. In this example, the character string “Reduce” is initially displayed though, after the slide transition, the character “Reuse” will be displayed. Thus, the persistent character objects 350 “R”, “e”, and “u” are present in both the first and second slide, though there is an intervening “d” in one slide but not the other.

In the depicted example, the non-persistent characters are slid away and faded from view as part of the transition while the persistent character objects 350 remain in view and are slid into their new positions consistent with the word displayed on the second slide. As in previous embodiments, the character objects 350 may be animated or manipulated independently of one another. As will be appreciated, the present example depicts letters, however the characters may also be numbers, symbols, punctuation and so forth. In addition, though the present example described sliding and fading (or retaining) of the characters, in other embodiments other types of character animation may be employed. For example, instead of sliding on the screen, the transition animation may instead rotate or flip the word about a vertical or horizontal axis, with the changes to the word being accomplished during the rotation or flip of the word. Indeed, any suitable form of character animation may be employed in manipulating characters in such an embodiment. Further to the extent that a character or character string may be present multiple times on either or both of the outgoing and incoming slide, in certain embodiments matching processes, such as those described with respect to FIGS. 10 and 11, may take into account the distance between characters or character strings in assigning matches. For example, if multiple possible matches are present for a character string found on the first slide 212 and the second slide 214, one factor in assigning a match may be the distance between the possible matches, with one implementation assigning matches which provide the shortest path moves.

The preceding describes various embodiments of object aware transitions, such as may be implemented in a slideshow presentation or by a presentation application. In certain embodiments, the objects may constitute the components of a composite graphic, such as a composite data graphic (e.g., a chart, graph, or other graphical data representation) used to visually represent an underlying set of data. In such embodiments, the objects forming the respective composite data graphic may be processed as discussed herein to effect transitions between different data graphics (e.g., charts, graphs, and so forth) and/or between different sequential slides on which the respective composite data graphics are associated.

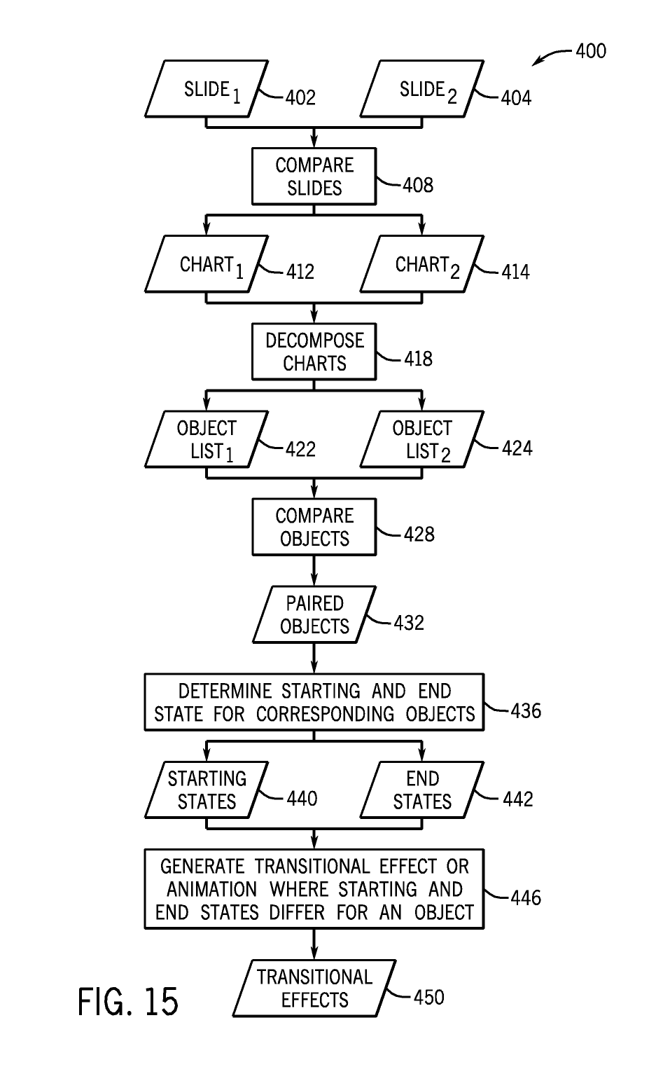

For example, turning now to FIG. 15, a flowchart 400 is provided depicting one example of an approach suitable for implementing a transition between composite data graphics on sequential slides of a slideshow presentation. In accordance with this example, the flowchart 400 depicts an algorithm having inputs, outputs, and processes that may be used in identifying suitable data graphics, here depicted as charts, and implementing a transition between the charts as part of a slide transition. As will be appreciated the control logic represented by flowchart 400 may be provided as one or more computer-executable algorithms stored and/or executed on a suitable electronic device 100, as discussed herein.

Turning to flowchart 400, in the depicted example a pair of sequential slides 402, 404, such as an outgoing slide and an incoming slide of a slideshow presentation, are compared (block 408) to determine if comparable composite data graphics are present in the respective slides 402, 404. In this example, the comparison process identifies respective charts 412, 414 present on the respective slides 402, 404.

As discussed herein, the respective charts 412, 414 are decomposed (block 418) to derive the respective lists 422, 424 of chart objects constituting the respective charts 412, 414. As discussed herein, the various chart objects composing the charts 412, 414 may possess various attributes, such as position, shape, style, size, opacity, rotation, text or numeric characters and/or content, color, fill, z-order position, underlying data, and so forth. Examples, of objects composing the charts 412, 414 may include, but are not limited to, axes, gridlines, labels, titles, numbers, words and letters, tick marks, legends, background, geometric data representations (e.g., bars, lines, wedges, and so forth), symbols, and so forth. As discussed herein, the objects constituting the charts 412, 414 may be processed (moved, rescaled, rotated, faded in or out) individually, i.e., without reference to other objects constituting the respective charts.

In the depicted example, a comparison (block 428), such as a pairwise comparison, is made between the respective lists 422, 424 of chart objects to generate a list 432 of paired objects for the charts 412, 414. That is, for each object in first chart 412, a corresponding object in second chart 414 is identified and vice versa. Alternatively, if no corresponding object can be identified in the other chart, a corresponding object may be generated or designated and assigned a position, opacity, rotation, shape, and so forth that will allow a transition to be generated, as discussed below.

In one embodiment, the comparison may pair objects at least partly based on similarity of shape, position, color, fill, proximity, z-order, and/or text or numeric, i.e., like objects may be paired with like objects. Such pairings may be subject to certain constraints, such as constraints based on proximity, the desirability to generate as many pairings as possible from existing objects, and/or limits imposed on the types of transitions to be employed (i.e., changes in font may not be desired even if the underlying text objects are otherwise identical or similar). In addition, in certain embodiments, only objects having comparable logical meanings or constructions within the chart may be paired. That is, in such an embodiment, axes may be paired with other axes but not with text, numbers, or bars, wedges, or lines representing data values. Likewise, objects representing data values may be paired with other objects representing data values, but not with objects that don't represent data values. In addition, the comparison process may pair objects at least partly based on the underlying data associated with the chart object. For example, if an object in outgoing chart 412 is associated with a particular set of data and an object in the incoming chart 414 is associated with the same underlying data or modified values of such data, the objects based on the corresponding data may be paired.

Respective starting states 440 and ending states 442 for each pair of chart objects is determined (block 436). In one embodiment, the starting state 440 for an object corresponds to one or more of the object's position, shape, data, style, and so forth, in the chart 412 associated with the outgoing slide 402. Likewise, in such an embodiment the end state 442 for an object corresponds to one or more of the object's position, shape, data, style, and so forth, in the chart 414 associated with the incoming slide 404.

In implementations in which an object is generated to correspond to an existing object in the other chart to create an object pair, the starting state 440 or end state 442 for the generated object may be determined based upon the properties of the corresponding object. For example, the generated object may be positioned, sized, and shaped to correspond to corresponding object, but assigned an opacity of zero. In such an example, the corresponding object may be observed to fade-in or fade-out of view during the transition. Alternatively, for such a generated object, the position and/or shape may differ from the corresponding object so that the corresponding object appears to slide in or out or to zoom in or out during the transition, as discussed in greater detail below.

Once the start and end states 440, 442 for each paired object are determined, suitable transitional effects 450 (e.g., animations) may be generated 450 based on these start and end states 440, 442 and a time interval associated with the transition. For example, as discussed herein, the transitional effects 450 may include one or more of rotating an object, translating an object, changing the scale of an object, and/or changing the opacity of an object over the time interval so that each object is respectively transitioned from its start state 440 to its end state 442 during the transition from the outgoing slide 402 to the incoming slide 404. In this manner, those objects that differ between the first chart 412 and the second chart 414 are transitioned (e.g., animated). Conversely, those objects that do not differ between the first chart 412 and the second chart 414 are not transitioned or redrawn, in contrast to techniques in which the entire second chart 414 is drawn when transitioning from the outgoing slide 402 to the incoming slide 404.

The generation of transitional effects 450 may be completely or partially determined by the types of differences between the starting state 440 and ending state 442 for associated with paired objects. For example, if the differences between the starting state 440 and ending state 442 may be resolved using certain basic animations (e.g., translation, scaling, rotation, and/or changes in opacity), the transitional effect 450 generated for the object pair may be an animation generated based on the time interval associated with the transition. When applied, the animation may move, rotate, resize, or change the opacity of the object from how it appears in the outgoing chart 412 to how it appears in the incoming chart 414. Alternatively, if the differences between the starting state 440 and ending state 442 may not be resolved or resolved easily using animation techniques, the transitional effect 450 generated for the object pair may be a fade-out of the object from the outgoing chart 412 and a fade-in of the paired object in the incoming chart 414 over the time interval associated with the transition. In some embodiments, the generation (block 446) of the transitional effects 450 may be based, at least partially, on the underlying data associated with the respective objects.

In such embodiments, changes in the data represented by an object may be used to determine the type or extent of transitional effect to apply when transitioning from the first chart 412 to the second chart 414. For example, in one embodiment, for paired chart objects that represent an underlying set of data, the starting state 440 and the ending state 442 for a paired object may be determined from an initial value and a subsequent value of the represented data. Intermediate or interpolated values for this data may be calculated, based the time interval allotted for the transition, to determine the animation bridging the starting state 440 and ending state 442 for the object pair.

While the foregoing flowchart 400 describes one implementation in which a pair of composite data graphics, represented by charts 412, 414, undergo a transition as part of a transition between outgoing and incoming slides 402, 404, it should be appreciated that the present approaches may be applicable in other contexts as well, such as in non-slideshow contexts or in contexts where a composite data graphic is transformed or transitioned in response to a change in the underlying data, a change in the specified style (e.g., bar chart, pie chart, line graph, and so forth), and/or a specified geometry or size of the data graphic. For example, the approaches discussed herein may be used in other work productivity applications, such as the Numbers® software package available from Apple Inc as part of the iWork® productivity package, to implement chart transitions or animations reflecting changes, such as those described above, made with respect to an existing data graphic.

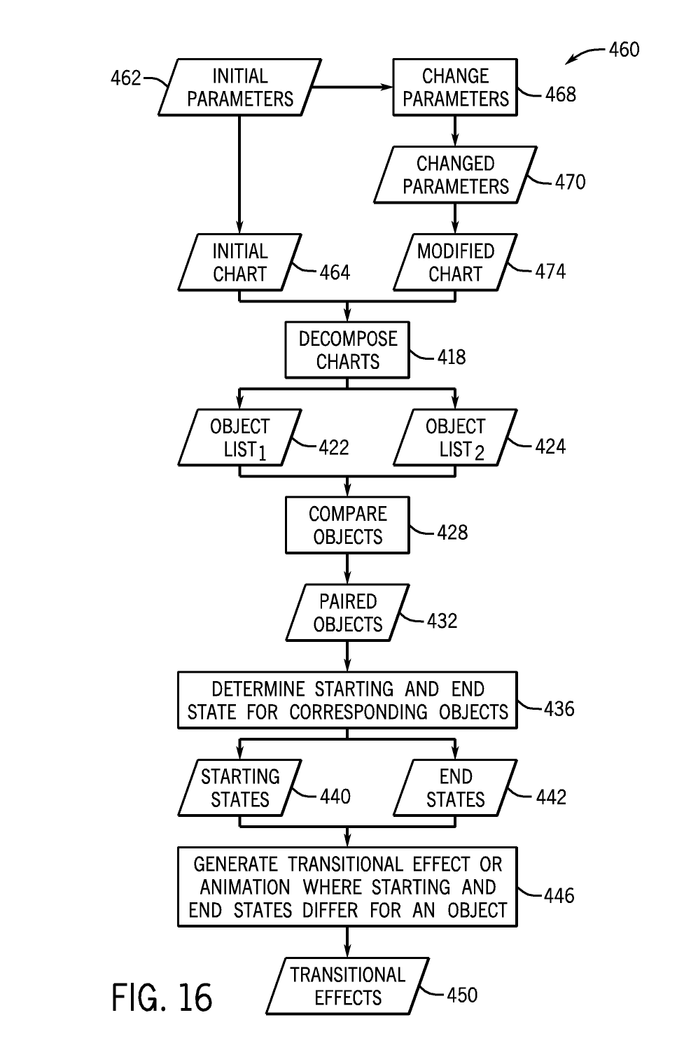

For example, turning to FIG. 16, a flowchart 460 is provided depicting one example of an approach suitable for implementing a transition after a change of parameters (e.g., chart style, underlying data, chart geometry or size, and so forth) associated with a composite data graphic. In accordance with this example, the flowchart 460 depicts examples of inputs, outputs, and processes that may be used in identifying suitable data graphics, here depicted as charts, and implementing a transition between the charts after a change in parameters. As will be appreciated the control logic represented by flowchart 460 may be provided as one or more computer-executable algorithms stored and/or executed on a suitable electronic device 100, as discussed herein.

As depicted in FIG. 16, an initial chart 464 may be defined by one or more initial parameters 462, such as the data (e.g., tabular data) represented by the chart 464, the user selected chart type, the chart placement and/or size, and so forth. In the depicted implementation, one or more of the initial parameters 462 are changed (block 468), such as by action of an operator or user, to a set of changed parameters 470 that may be represented as a modified chart 474. For example, the changed parameters 470 may represent changes to the underlying data (e.g., a changes made in a table of data) represented by the charts that results in the modified chart having one or more chart objects (such as bars, lines, wedges, and so forth) that differ from the initial chart 464. To bridge or transition the differences between the initial chart 464 and the modified chart 474 when displayed, one or more transitional effects 450 may be generated and implemented over a period of time (e.g., half a second, one second, two second, five seconds, and so forth), as discussed above. Thus, in response to the changes in data and/or parameters, the initial chart 464 and modified chart 474 may be decomposed (block 418) into constituent objects which may be compared (block 428) and paired to determine start and end states 440, 442 used in the generation (block 446) of transitional effects 450 that may be employed when transitioning from the display of the initial chart 464 to the modified chart 474.

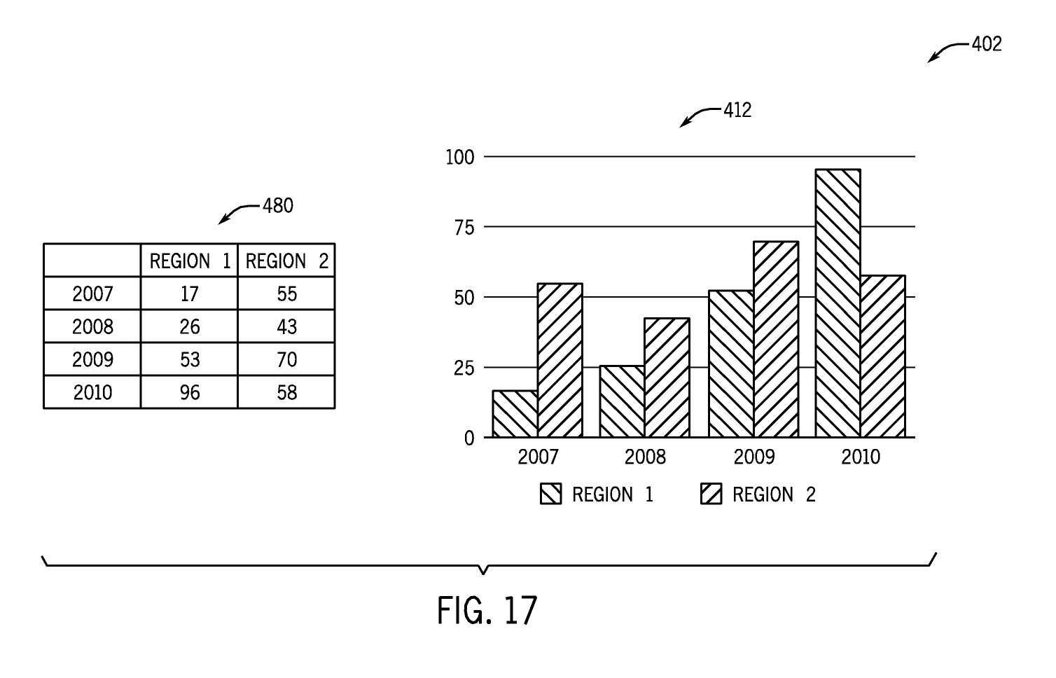

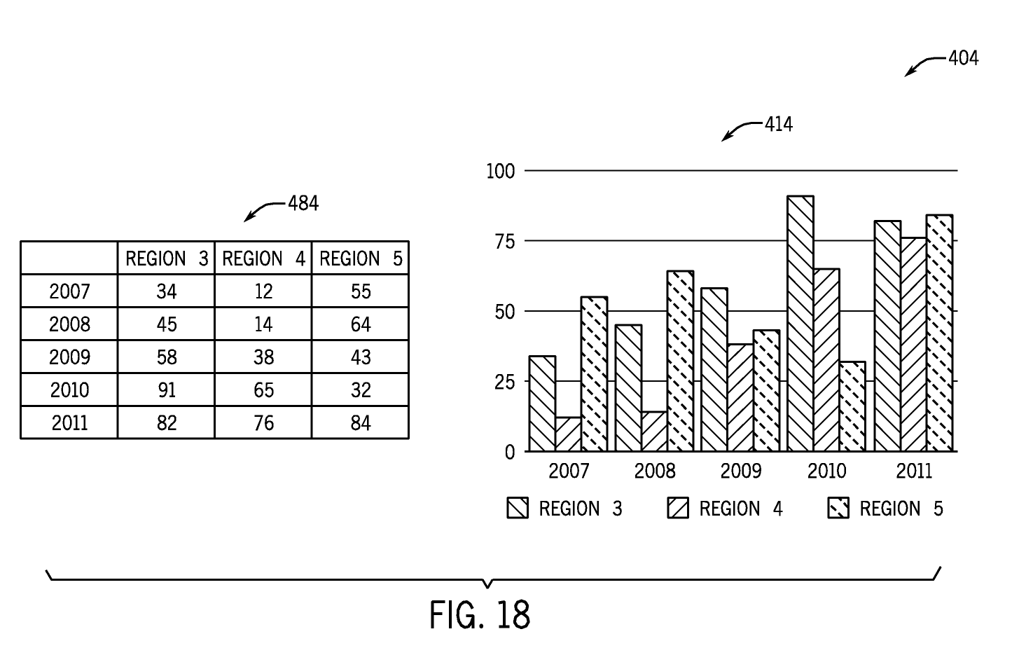

With the foregoing discussion in mind and by way of example, FIGS. 17 and 18 depict respective first slide 402 and second slide 404 of an implementation of the present approaches in a slideshow presentation. In accordance with this example, the first slide 402 may include a first set of data 480 and a composite data graphic, here provided as first chart 412, visually representing the data 480. Likewise, the second slide 404 may include a second set of data 484 and a composite data graphic, here provided as first chart 414, visually representing the data 484. In this example, the second set of data 484 differs from the first set of data 480 in that three different “regions” are represented instead of two and in that an additional year of data is provided. These differences are respectively reflected in chart 412 and in chart 414.

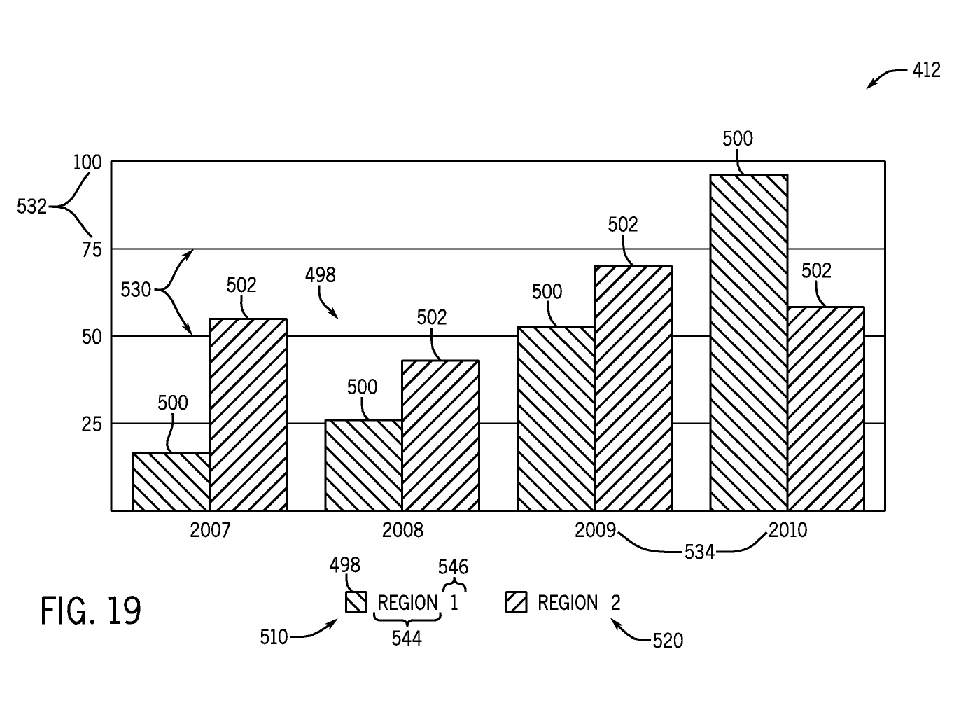

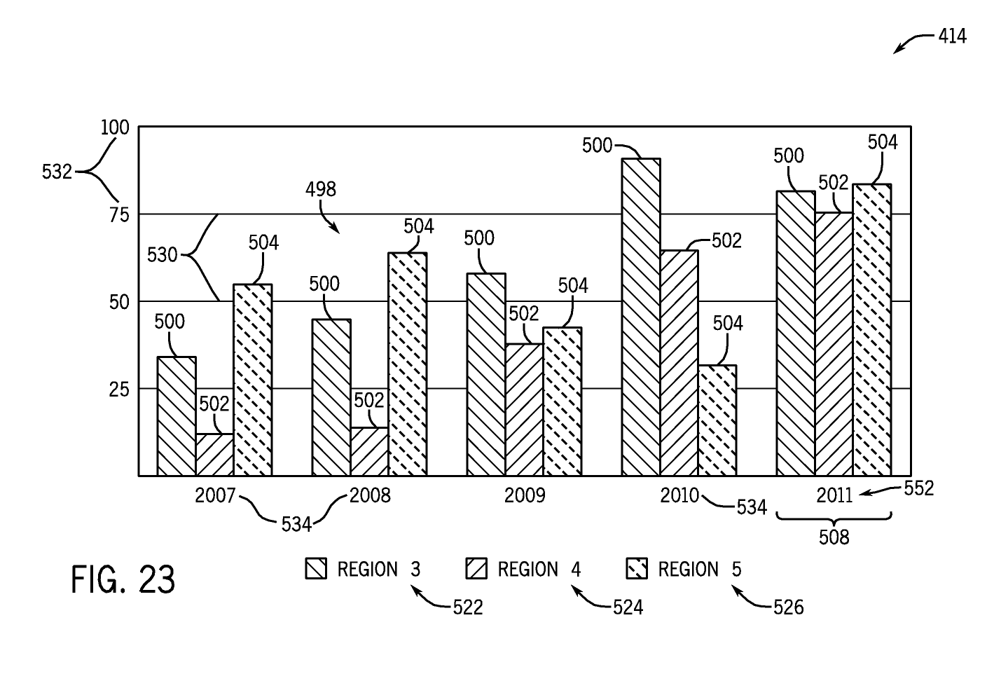

In transitioning from the first slide 402 to the second slide 404, and thus from the chart 412 to chart 414, it may be desirable to animate the transition between different objects within the charts while leaving like objects in place and unchanged. One such transition is depicted in FIGS. 19-23, where FIG. 19 depicts the first chart 412 of slide 402, FIG. 23 depicts the second chart 414 of slide 404 and slides 20-22 depict transitional steps in respective one-quarter steps (i.e., ¼, ½, and ¾ steps) that may be displayed as part of a transition from the first chart 412 to the second chart 414.

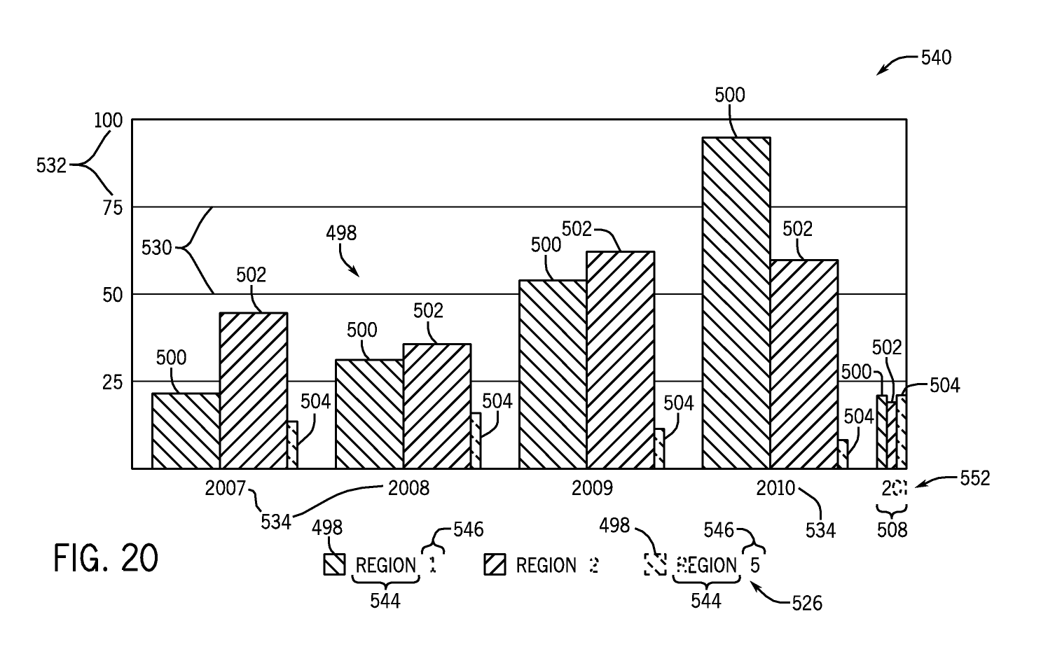

In this example, first chart 412 visually depicts (using graphical objects 498 in the form of bars) arbitrary data for two “regions” (e.g., “Region 1” and “Region 2”) over four years (2007-2010). The second chart 414 visually depicts arbitrary data for three “regions” (e.g., “Region 3”, “Region 4”, and “Region 5”) over five years (2007-2011) depicted in an area of the same height and length. Thus, the transitional steps depicted in FIGS. 20-22 represent the incremental addition of this additional data (i.e., three regions instead of two and five years instead of four) as well as changes in the data values for bars (i.e., graphical objects 498) that are determined to be present in both the first chart 412 and second chart 414. In addition, respective legends 490, 492 displayed with each respective chart are also incrementally transitioned to represent these differences.

For example, turning to the first chart 412 depicted in FIG. 19, the bars 500 corresponding to the “Region 1” data are depicted with a first hatching, as set forth by corresponding legend 510. Likewise, the bars 502 corresponding to the “Region 2” data are depicted with a second hatching, as set forth by corresponding legend 520. Likewise, “Region 3”, “Region 4”, and “Region 5” of second chart 414 included respective legends 524, 526, and 528.

In the incremental (e.g., ¼, ½, ¾) transition steps 540, 560, and 580 respectively depicted in FIGS. 20-22, it is assumed, for the purpose of illustration, that the bars corresponding to the first and second regions will be transitioned to bars representing, respectively, the third and fourth regions represented in the second chart 414. In particular, for the purpose of illustration, the “Region 1” bars 500 associated with the respective years 2007-2010 are assumed to be paired with corresponding “Region 3” bars for the same respective years. Likewise, the “Region 2” bars 502 associated with respective years 2007-201 are assumed to be paired with corresponding “Region 4” bars for the same respective years.

As the years 2007-2010, in the first chart 412 do not have a third region for each year but such a region is present in the second chart 414, the widths of the bars 500, 502 corresponding, respectively, to the first/third and second/fourth regions are incrementally reduced in width (i.e., changed in scale) in each of the incremental transition steps 540, 560, and 580 to accommodate a third bar 504. Conversely the third set of bars 504 is introduced for each of the years 2007-2010 such that the bars are incrementally increased in width (i.e., changed in scale) from an initial assigned value (e.g., zero width) such that in the second chart 414 the third set of bars 504 are equal in width to the first and second sets of bars 500, 502. While not presently depicted, in other implementations other animation techniques, such as changes in opacity, may be used to gradually introduce the third set of bars 504 corresponding to the added region. For example in addition to or instead of scaling the bars 504 to their position and size in the second chart 414, the bars 504 may be gradually increased in opacity, such as from 0% opacity to 100% opacity, over the course of the transition depicted in FIGS. 19-23.

Likewise, as noted above, the first chart 412 stops at the year 2010 while the second chart 414 visually depicts data for an additional year, i.e., 2011. Therefore, in the depicted example, to transition from the first chart 412 to the second chart 414 an additional set of bars 508 representing the data for the year 2011 is transitioned in from the right-hand side of the chart in the incremental transition steps 540, 560, and 580. In the depicted transitional steps the set of bars 508 is slid (i.e., translated) in from the side while the bars corresponding to previously displayed years are also translated toward the left to provide space for the added set of bars 508.

In addition, in the depicted implementation, each of the added set of bars 508 is initially introduced at reduced widths, with each corresponding sets of bars 500, 502, and 504 within set 508 being incrementally increased in width (i.e., increased in scale) from an initial assigned value (e.g., zero width) such that in the second chart 414 the added bars 508 for the year 2011 are equal in width to the bars representing data in the years 2007-2010. In addition, due to the addition of the additional year of data and the additional region of data, the sets of bars 502 and 504 associated with the initially present years 2007-2010 are decreased in width (i.e., decreased in scale) to accommodate the bars representing the added year and region data (i.e., bars 504 and 508).

Further, as discussed above with respect to adding bars 504, other animation techniques, such as changes in opacity, may be used to gradually introduce the bars 508 representing the added year of data. For example in addition to or instead of translating and scaling the bars 508 to their position and size in the second chart 414, the bars 508 may be gradually increased in opacity, such as from 0% opacity to 100% opacity, over the course of the transition depicted in FIGS. 19-23.

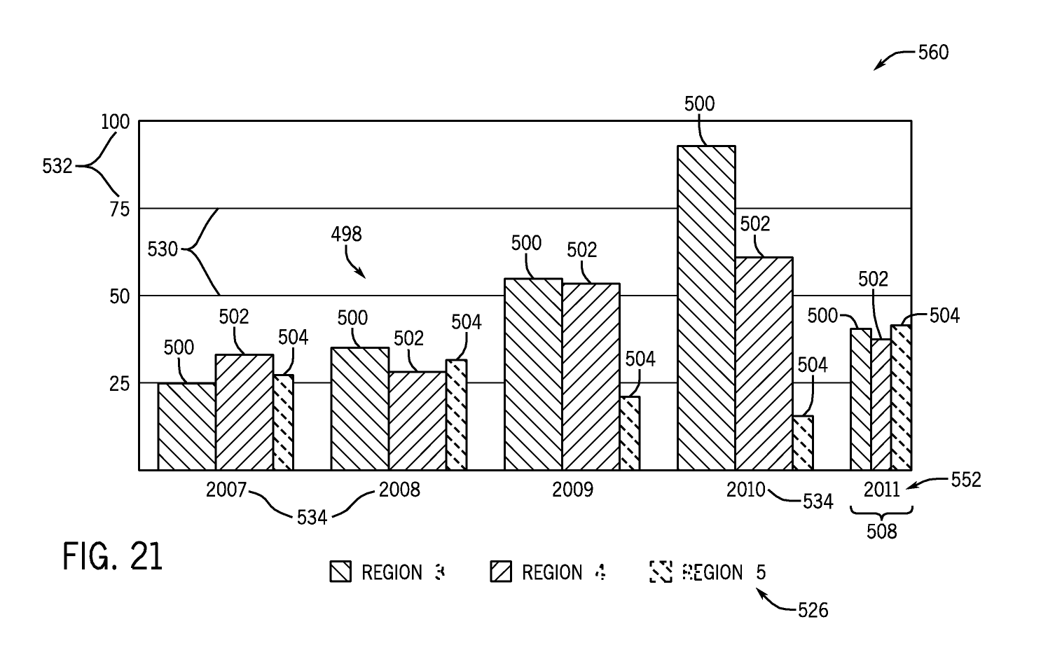

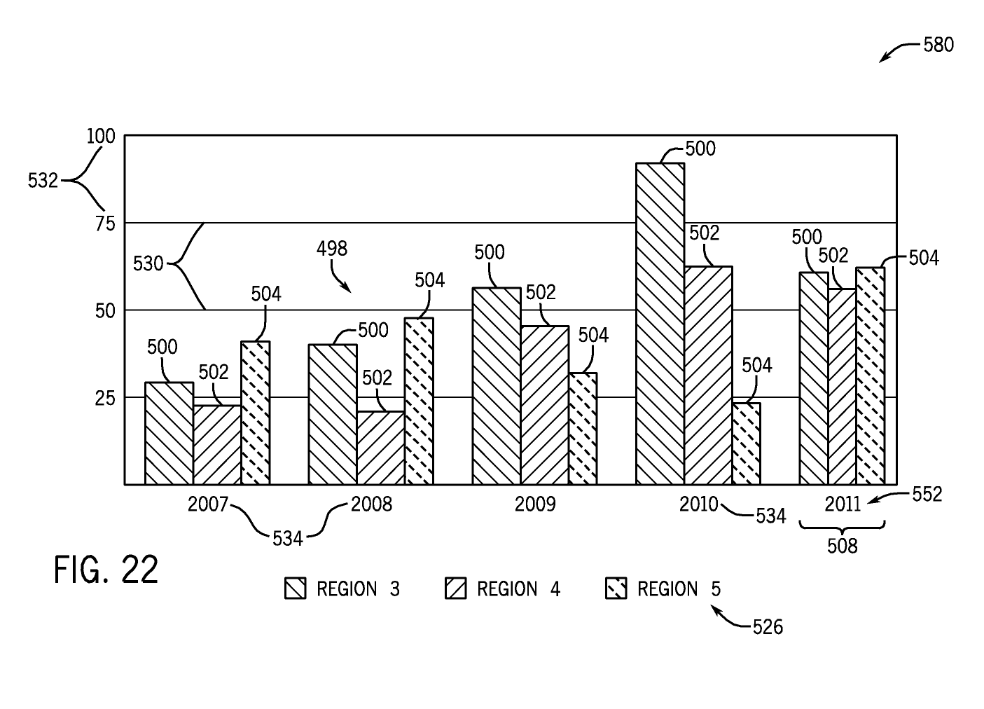

In addition to accommodating additional data sets (i.e., additional years and regions in the depicted implementation), the data bars 500, 502, and 504 may represent different data values in the first chart 412 and second chart 414. In such an implementation, the paired objects may be scaled to address changes in the underlying data represented by an object. For example, in the first chart 412, “Region 2” has a value of “43” in the year “2008” while paired “Region 4” has a value of “14” in the year “2008”. Thus, in transitioning between the first chart 412 and the second chart 414 in an embodiment, in which the bars 502 are paired to represent both “Region 2” and “Region 4”, the bar representing Regions 2 and 4 in the year 2008 may be scaled or otherwise transitioned to reflect the change in the underlying data between the charts. For example, as noted above, in the first chart 412, the bar corresponding to Region 2 in the year 2008 is drawn to correspond to a value of “43” while in the second chart, the bar corresponding to Region 4 in the year 2008 is drawn to correspond to a value of “14”. Thus, in this example, the quarter-wise transitions for this respective bar are scaled vertically to reflect convergence on the final value (i.e., “14”) in quarter increments of the difference between the starting and final value. For example, in FIG. 20 the bar in question is drawn to correspond to a data value of “35.75”, in FIG. 21 the bar in question is drawn to correspond to a data value of “28.5”, and in FIG. 22, the bar in question is drawn to correspond to a data value of “21.25”.

Likewise, with respect to the added bars 504 and 508, each added bar (i.e., a bar present in the second chart 414 but not the first chart 412) may be paired with a generated bar that is initially assigned a value of “0”. That is, the transition for each added bar 504 or 508 begins as if the bar being added represented a data point having a value of “0” at the beginning of the transition. For example, with respect to the bar 504 representing the year 2011, this bar is present only in the second chart 414 and is drawn to correspond to a data value of “84” in the second chart 414. As there is no corresponding bar in the first chart 412, this bar is paired with a bar generated for the first chart 412 that, in this example, corresponds to a data value of “0”. Thus, in this example, the quarter-wise transitions for this respective bar are scaled vertically to reflect convergence on the final value (i.e., “84”) in quarter increments of the difference between the starting and final value. For example, in FIG. 20 the bar in question is drawn to correspond to a data value of “21”, in FIG. 21 the bar in question is drawn to correspond to a data value of “42”, and in FIG. 22, the bar in question is drawn to correspond to a data value of “63”. As will be appreciated, in addition to the depicted scaling effect, other effects, such as increases in opacity from transparent to opaque, translation effects, or other animation effects, may be employed to depict the transition of a bar or other data object where there is a change in the underlying data value being represented such as to or from zero or any other suitable data value.

While the foregoing generally describes how objects representing underlying data (here depicted as bars of a chart) may be transitioned in using animation techniques as part of a slide or chart transition, it should be understood that the same approaches may be used to remove data representations if the differences between two charts warrant such removal. For example, objects representing data may be transitioned off a first chart 412 if no corresponding object is present on a second chart 414 by reducing the object in scale, translating the object off the side of the chart, and/or decreasing the opacity of the object to remove the object from view. In this manner, data differences underlying two composite graphical representations may be accommodated by creating the appearance of adding or removing corresponding objects representing the data as part of the a transition process.

While objects representing data are discussed above, a composite data graphic, such as a chart, may also include objects that do not represent a set of underlying data but represent various display features associated with the graphic. For example, axes, titles, legends, labels, gridlines, and so forth are examples of objects that may be included in such a graphic and which may also be subject to transitional effects as discussed herein. For example, the first chart 412 and second chart 414 depicted in FIGS. 19 and 23 include legends 510, 520, 524, 526, and 528. Likewise, the first chart 412 and second chart 414 include respective gridlines 530, Y-axis labels 532, and X-axis labels 534 all or part of which may be subject to transition effects as discussed herein.

For example, with respect to the legends 510, 520, 522, 524, and 526, these objects may themselves be composite objects that include a graphical object 498 depicting a color, hatching or shade of gray, as well as a text object 544 and/or numeric object 546 associating the color, hatching or shade of gray depicted by the graphical object 498 with a set or type of data. In the depicted example, legends 510 and 520 representing “Region 1” and “Region 2” respectively in first chart 412 and legends 522 and 524 representing “Region 3” and “Region 4” respectively in second chart 414 have identical graphical objects 498 and text objects 544, but different numeric objects 546 (i.e., “1” and “3”; “2” and “4”). In addition legends 510 and 522 and legends 520 and 524 differ in position with respect to one another due to the addition of legend 526, which is present in second chart 414 but has no corresponding structure or objects in the first chart 412.

Therefore, as part of the transition depicted in FIGS. 20-22, legend 510 may be transitioned to legend 522 and legend 520 may be transitioned to legend 524 by translating the respective legends toward the left on the chart from the respective locations of legends 510 and 520 on first chart 412 to the respective locations of legends 522 and 524 on second chart 414. In addition, the respective numeric objects 546 may be transitioned from “1” to “3” and from “2” to “4”. In the depicted embodiment, the transition of the numeric elements is performed by fading out (i.e., decreasing the opacity of) the numeric elements 546 in the legends 510 and 520 associated with the first chart 412 (i.e., “1” and “2”) and by fading in (i.e., increasing the opacity of) the numeric elements 546 in the legends 522 and 524 associated with the second chart 414 (i.e., “3” and “4”).

In addition, the legend 526 present in the second chart 414 has no corresponding counterpart in the first chart 412. Therefore, as part of the transition depicted in FIGS. 20-22, the legend 526 corresponding to the “Region 5” of second chart 414 may be brought into view by increasing the opacity of the constituent objects of the legend 526 (i.e., the corresponding graphic element 498, the textual element 544, and the numeric element 546), such as from 0% to 100%. In addition, the legend 526 may also be translated as the opacity is increased so that it appears to move with other legends during the transition or with the data bars in the body of the chart. To accomplish these transitional effects for the legend 526, the constituent objects of the legend 526 may be paired with generated objects (i.e., objects not initially present in the first chart 412) that have a suitable degree (or absence) of opacity and a suitable placement to provide to provide a suitable starting state 440 to achieve the desired transitional effect when transitioning from the first chart 412 to the second chart 414.

Similar to the legend 526, the data label 552 (i.e., the label “2011” representing the additional year added in second chart 414) has no corresponding counterpart in the first chart 412. Therefore, as part of the transition depicted in FIGS. 20-22, the data label 552 may be brought into view by translating the data label 552 in from off screen. For example, in the depicted implementation, the data label 552 is translated on-screen in conjunction with the added bars 508, with which it corresponds. Thus at the beginning of the transition, the only some of the characters of the data label 552 may be visible (e.g., “20”) while, as the translation progresses, the remaining characters may become visible and may translate to their destination position in chart 414. Further, the transition of the data label 552 may include an increase in opacity in conjunction with the translation. In such an implementation, the transition of the data label 552 may begin with the data label having little or no opacity (e.g., 0%) and may end with the data label 552 having increased or full opacity (e.g., 100%) such that the opacity is increased throughout the transition. Because there is no data label corresponding to the data label 552 in the first chart 412, the legend 526 may be paired with a generate label (i.e., a label object not initially present in the first chart 412) that is assigned a suitable degree (or absence) of opacity and a suitable placement to provide to provide a suitable starting state 440 to achieve the desired transitional effect when transitioning from the first chart 412 to the second chart 414.

It should be appreciated that other concepts discussed herein, such as the concepts of hard and soft matches and the attendant animations that may be generated for soft matches as compared to hard matches, are equally applicable to objects used in charts or other composite data graphics, as discussed herein. For example, in the context of a data bar, label, legend, title, gridline, axis, and so forth, a corresponding object may be defined by parameters such as color, angle, offset, blur, opacity, and position. In such an example, differences in angle, offset, opacity, and/or position for an object deemed to be object present in both an outgoing and incoming slides may still allow the object to be classified as a hard match in both slides. However, differences in font, blur and/or color for the object between the outgoing and incoming slides may result in the object being classified as a soft match, with corresponding adjustments being made to the transitional animation process when needed.

Further, it should be appreciated that the identification and matching processes discussed herein may be modified to leverage a known relationship between two objects in different slides and/or charts (or other composite data graphics. For example, known data relationships or relationships between characteristic portions of a graph or chart (such as vertical axes, horizontal axes, legends, gridlines, titles, and so forth, may be leveraged when performing the identification and/or matching processes, even if the appearance of the corresponding object is different in the two slides or charts. Conversely, in one embodiment objects associated with different data or data types or portions of a chart or other data graphic may not be matched and can generally be clearly categorized as different objects.

As will be appreciated, the present techniques allow for identification of objects on slides of a presentation or in other non-slideshow contexts (such as part of a spreadsheet, budget tracking or planning, bookkeeping, tax-preparation, database or other application that may use composite data graphics, such as charts or graphs). Further, the disclosed techniques allow for the independent manipulation, such as animation, of the objects during transitions between data graphics, such as during a slide transition or upon a change to a chart style or to data represented by the data graphic. As described herein, in some embodiments, the presence of an object or objects in sequentially displayed composite data graphics may be determined and manipulation of the objects during the transition may account for the persistence of the objects. In certain embodiments, as described herein, the identification of objects and/or the transitional manipulation of the identified objects may be automatically derived, such as by an application executing on a processor-based system.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for generating an effect for an object associated with a graphical data representation, comprising:
identifying a first object present in a first graphical data representation;
identifying a second object present in a second graphical data representation;
matching the first object and the second object;
generating a transitional effect animating a transition from the first object to the second object; and
displaying the transitional effect when transitioning from the first graphical data representation to the second graphical data representation.

2. The method of claim 1, wherein the first object and the second object represent structural features of the respective first graphical data representation and the second graphical data representation.

3. The method of claim 1, wherein the second graphical data representation corresponds to the first graphical data representation after a change to one or more of a set of underlying data, a specified style, or a specified geometry or size.

4. The method of claim 3, wherein each object of each graphical data representation has a different z-order.

5. The method of claim 1, the first object and the second object are matched based at least in part on the type of feature that they represent within the respective graphical data representation.

6. The method of claim of claim 1, wherein the first object and the second object represent the same or similar types of data values.

7. The method of claim 1, wherein the first graphical data representation and the second graphical data representation comprise respective charts or graphs.

8. The method of claim 7, wherein the first object and the second object comprise one or more of axes, gridlines, labels, titles, numbers, words and letters, tick marks, legends, background, or geometric data representations.

9. A method for transitioning between composite data graphics, comprising:
decomposing a first composite data graphic into a first set of objects;
decomposing a second composite data graphic into a second set of objects;
performing a matching operation on the first set of objects and the second set of objects to determine a set of corresponding objects in the first set of objects and the second set of objects
generating an animation that transitions the set of corresponding objects from how each corresponding object appears in the first composite graphic to how the respective corresponding object appear in the second composite graphic; and
executing the animation when transitioning form the first composite data graphic to the second composite data graphic.

10. The method of claim 9, comprising:
generating a respective corresponding object for one or more objects present only in the first composite data graphic or only in the second composite data graphic.

11. The method of claim 9, wherein the first set of objects and the second set of objects comprise objects representing data values.

12. The method of claim 9, wherein the first set of objects and the second set of objects comprise objects representing display features of the first composite data graphic or the second composite data graphic.

13. The method of claim 9, wherein the matching operation comprises a pairwise comparison.

14. The method of claim 9, wherein the second composite data graphic corresponds to the first composite data graphic after a change to one or more of a set of underlying data, a specified style, or a specified geometry or size.

15. Computer-readable media comprising a computer program product, the computer program product comprising routines which, when executed on a processor, perform the following:
matching a first object present in a first composite data graphic with a second object present in a second composite data graphic;
generating a transition which, when executed, performs one or more of a translation, a rotation, a change in scale, or a change in opacity, which causes the first object in the first composite data graphic to transform into the second object in the second composite data graphic.

16. The computer-readable media of claim 15, wherein the routines of the computer program product, when executed on the processor, perform the following:
executing the transition when the second composite data graphic is displayed after the first composite data graphic.

17. The computer-readable media of claim 15, wherein the computer program comprises a presentation application, a spreadsheet application, or a database program.

18. The computer-readable media of claim 15, wherein matching the first object with the second object occurs as the result of a pairwise comparison of objects in the first composite data graphic and the second composite data graphic.

19. The computer-readable media of claim 15, wherein the routines of the computer program product, when executed on the processor, perform the following:
decomposing the first composite data graphic and the second composite data graphic to generate respective lists of objects that compose the respective first composite data graphic and the second composite data graphic and that include the respective first object and second object.

20. An electronic device suitable for the display of data, the electronic device comprising:
a display;
a processor configures to execute one or more routines stored in a memory or data storage structure; and
a memory or data storage structure encoding code which, when executed by the processor, causes the display of a first composite data graphic on the display, wherein the first composite data graphic comprises a first plurality of objects, determines a pairwise match between some or all of the objects in the first plurality of objects with some or all of a second plurality of objects associated with a second composite data graphic, generates one or more transitional effects for the pairswise matched objects, and causes the display of the one or more transitional effects on the display when transitioning from displaying the first composite data graphic to displaying the second composite data graphic.

21. The electronic device of claim 20, wherein the one or more transitional effects comprise animations depicting translation, rotation, change in scale, or change in opacity between how an object appears in the first composite data graphic and how a paired object appears in the second composite data graphic.

22. The electronic device of claim 20, wherein some or all of the first plurality of objects and the second plurality of objects represent data values.

23. The electronic device of claim 22, wherein the one or more transitional effects address differences in the data values between the first composite data graphic and the second composite data graphic.
